(19) United States
(12) Patent Application Publication
(10) Pub. No.: US 2018/0074798 A1
(43) Pub. Date: Mar. 15, 2018

(54) VISUALISATION FOR GUIDED ALGORITHM DESIGN TO CREATE HARDWARE FRIENDLY ALGORITHMS

(71) Applicant: CANON KABUSHIKI KAISHA, Tokyo (JP)

(72) Inventors: JUDE ANGELO AMBROSE, Blacktown (AU); ALEX NYIT CHOY YEE, Ryde (AU); IFTEKHAR AHMED, North Ryde (AU)

(21) Appl. No.: 15/701,105

(22) Filed: Sep. 11, 2017

(30) Foreign Application Priority Data
Sep. 13, 2016 (AU) 2016228166

(51) Int. Cl. G06F 9/44; G06F 9/45

(52) U.S. Cl. CPC G06F 8/35; G06F 8/4434; G06F 8/71; G06F 8/4441

(57) ABSTRACT

A method of selecting a software code optimisation for a section of algorithm software code in order to modify resource usage of hardware, the method comprising the steps of classifying each of a plurality of software code optimisations each characterising modifications to the section of software code that modify the hardware resource usage, forming combinations of the software code optimisations, each containing at least two of the software code optimisations and being formed according to an interdependency of the optimisation techniques of the software code optimisations in the combination, wherein the software code optimisations of each combination are useable together, and modifying the section of software code with at least two of the software code optimisations belonging to a selected combination of the set of combinations in order to modify the resource usage of the hardware executing the section of software code.

### TECHNICAL FIELD

The present invention relates to automation tools for designing digital hardware systems in the electronics industry and, in particular, to automation tools for improving algorithm software code for execution on embedded hardware.

### BACKGROUND

At present, an algorithm developer implements an algorithm, in the form of software code, in order to satisfy required functionality and to meet the functional aspects, such as accuracy.

FIG. 2 shows an example of a process 200 for developing an algorithm and implementing the algorithm in hardware. Once an algorithm software code 202, typically developed in a high level language such as C++ is considered to be complete by an algorithm developer 201, the code 202 is passed to an embedded developer 203 which converts, as depicted by an arrow 207, the algorithm software code 202 to a form that is suitable for execution on a hardware platform (not shown) by converting or optimising the algorithm software code 202 to embedded code 204. The “embedded code” is the code which can be executed in the target embedded hardware.

If the embedded developer 203 finds any issues in the algorithm software code 202 which require modification in order to ensure hardware compatibility, the algorithm software code 202 is returned, as depicted by an arrow 208, to the algorithm developer 201 for modification and verification.

For example, if the hardware platform upon which the embedded code 204 is to execute does not have any floating point computation modules, the algorithm software code 202 needs to be modified so that it does not include any floating point variable types, because these might affect the expected precision of the algorithm. In such a case the algorithm developer 201 updates the algorithm software code 202 by analysing the precision of the algorithm and might even update the fundamentals of the algorithm to reach the expected precision without using floating point operations.

Depending on the complexity of the algorithm software code 202 and the hardware friendliness required for execution on a hardware platform, the iteration 208 between the algorithm developer 201 and the embedded developer 203 can have significant impact in terms of the cost incurred and the time taken to produce the final algorithm software code 202 which is suitable for conversion to the embedded code 204 for execution in the hardware platform.

The “hardware friendliness” of the algorithm software code 202 is the extent of compliance of the algorithm software code for mapping onto a generalised hardware platform, such as processor based hardware, multicore based hardware, Field Programmable Gate Array (FPGA) or an Application Specific Integrated Circuit (ASIC). The “hardware friendliness” can, for example, refer to algorithm code not containing constructs such as recursions or pointer reassignment which are not suitable to implement in hardware. Another example would be the memory consumption and gate count being close to the platforms available in the market, such as an algorithm consuming less than 1 giga bytes (GB) compared to consuming 100 GB.

Currently, the conversion 207 of the algorithm software code 202 to the embedded code 204 is mostly performed manually, and the embedded developer 203 can use profiling and tracing tools to analyse the algorithm software code 202 in order to assist during the conversion. When considered with multiple optimisations for different metrics, such as memory consumption, band rate (ie the number of memory accesses), parallelisation, complexity and with different optimisation techniques within each metric, such as loop tiling, loop merging and loop fusion techniques for band rate metric, and data reuse and data reduction techniques for memory consumption metric, it is challenging to prioritise the possible algorithm software code optimisations for a systematic exploration in order to achieve the optimal embedded code 204 from the hardware execution point of view.

One possible solution is referred to as Guided Algorithm Design (GAD), where the algorithm developer 201 is assisted during development of the algorithm code 202 by information which assists the developer 201 to update the algorithm software code 202, the assistance sometimes taking the form of highlighting possible improvements in order to create hardware friendly algorithm software code 202.

It is challenging to compare different code optimisations and their benefits because these can be in different units (such as cycles, bytes, number of accesses, etc.). For example, it is difficult to compare (a) a benefit of 20 memory accesses reduction which results from using a loop tiling technique associated with the band rate metric against (b) a benefit of 100 bytes in savings resulting from using the data reuse technique of the memory consumption metric. Code optimisations which provide benefits in different units are referred to as unrelated code optimisations. Accordingly, finding the best set of code optimisations across different hardware metrics is challenging, however it is critical for the algorithm developer to easily explore code optimisations across different hardware metrics in order to improve the algorithm software code.

One method is to exhaustively try all combinations of different techniques during the algorithm software code analysis, which is time consuming and tedious. Hence a feasible approach is to analyse the algorithm software code separately for different techniques and then rank or prioritise the resulting code optimisations deduced.

In one known method, the feasible direction method is utilised to find the optimal solution for multiple objectives, by progressively finding better solutions based on the relationship between the objectives. While this technique has proven to be sound, the relationship between the objectives has to be clearly established to formulate the feasible direction for every move.

In another known method, unrelated properties, such as cost, NOx emission and SO2 emissions, are combined together in a weighted and summed formulation to determine the overall benefit. However this method presumes that the properties considered are of the same unit and have the same type of dependencies, and even with this presumption finding weights for unrelated properties is difficult.

In another known method, a composite metric is created for comparisons by normalising unrelated or independent metrics. For example, “power” is normalised against “reliability” to compare different optimisations. This technique can be used if the optimisations used for comparison do not change.

### SUMMARY

It is an object of the present invention to substantially overcome, or at least ameliorate, one or more disadvantages of existing arrangements, or at least provide a useful alternative.

Disclosed are arrangements, referred to as Interdependency Based Ranking (IBR) arrangements, which can be used with current Guided Algorithm Design (GAD) arrangements, the IBR arrangements aiming to address the above problems by classifying software code optimisations according to interdependency of the optimisation techniques associated with the software code optimisations and ranking the classified software code optimisations thereby providing a convenient and effective mechanism for guiding development of algorithm software code.

According to a first aspect of the present disclosure, there is provided a method of selecting a software code optimisation for a section of algorithm software code in order to modify resource usage of hardware that executes the section of algorithm software code, the method comprising the steps of: classifying each of a plurality of software code optimisations, each of the software code optimisations characterising modifications to the section of software code that modify the hardware resource usage; forming combinations of the software code optimisations, each of the combinations containing at least two of the software code optimisations and being formed according to an interdependency of the optimisation techniques of the software code optimisations in the combination, wherein the software code optimisations of each combination are useable together; and modifying the section of software code with at least two of the software code optimisations belonging to a selected combination of the set of combinations in order to modify the resource usage of the hardware executing the section of software code.

According to a second aspect of the present disclosure, there is provided a method of selecting software code optimisations for a section of algorithm software code to modify resource usage of hardware that executes the section of algorithm software code, the method comprising the steps of: displaying a plurality of software code optimisations for the section of software code, each of the software code optimisations characterising modifications to the section of software code that modifies resource usage; determining that one of the plurality of software code optimisations for the section of software code has been designated; and displaying at least one additional software code optimisation from the plurality of software code optimisations, the additional software code optimisation being displayed in a format dependent upon whether additional software code optimisation can be used together with the software code optimisation that has been designated

According to another aspect of the present disclosure, there is provided an apparatus for implementing any one of the aforementioned methods.

According to another aspect of the present disclosure there is provided a computer program product including a computer readable medium having recorded thereon a computer program for implementing any one of the methods described above.

Other aspects are also disclosed.

### BRIEF DESCRIPTION OF THE DRAWINGS

Some aspects of the prior art and at least one embodiment of the present invention will now be described with reference to the drawings and appendices, in which:

FIG. 1 is a schematic flow diagram illustrating a method that can be used to analyse, rank and report code optimisations according to one example of the disclosed IBR arrangement in order to optimise algorithm software code for hardware friendliness;

FIG. 2 is a schematic flow diagram illustrating a current method for generating embedded code from algorithm software code;

FIG. 3 is a schematic flow diagram illustrating a method for efficiently creating hardware friendly algorithms according to one example of the disclosed IBR arrangement;

FIG. 4 is a schematic flow diagram illustrating an example of the step 304 in FIG. 3 for performing real-time analysis and exploration of code optimisations in more detail;

FIGS. 5A, 5B, 5C and 5D is a set of example code snippets showing different metrics and code optimisation techniques according to one example of the disclosed IBR arrangements;

FIG. 6 is a schematic flow diagram illustrating an example of the step 405 in FIG. 4 for generating viable code optimisations for the given algorithm software code in more detail;

FIG. 7 illustrates an example of a ranking method usable in the step 109 for ranking code optimisations using different code optimisation techniques for multiple metrics according to one example of the disclosed IBR arrangements;

FIG. 8 is an example interdependency table of code optimisation techniques used in one example of the disclosed IBR arrangements.

FIGS. 9A, 9B, 9C and 9D is a numerical example to illustrate the ranking method used in the 109 in FIG. 1 according to one example of the disclosed IBR arrangements;

FIGS. 10A, 10B and 10C illustrates various visualisations of the interactive exploration feature used to explore the best set of code optimisations for the considered algorithm software code according to one example of the disclosed IBR arrangements;

FIG. 11 is a schematic flow diagram illustrating an example of the ranking step 109, given a requirement to rank for maximal benefit across many metrics as possible; according to one example of the disclosed IBR arrangements;

FIGS. 12A and 12B form a schematic block diagram of a general purpose computer system upon which one example of IBR arrangements described can be practiced;

FIG. 13 is a schematic flow diagram illustrating an example of the ranking method 109, given a requirement that the algorithm developer determines the priority of metrics according to one example of the disclosed IBR arrangements;

FIG. 14 is a schematic flow diagram illustrating an example of a method to interactively explore the code optimisations in the graphical user interface according to one example of the disclosed IBR arrangements;

FIGS. 15A, 15B and 15C is a set of example visual representations for the memory consumption metric according to one example of the disclosed IBR arrangements; and

FIGS. 16A and 16B is a set of example visual representations for the bandrate and complexity metrics according to one example of the disclosed IBR arrangements.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of documents or devices which may form public knowledge through their respective publication and/or use. Such discussions should not be interpreted as a representation by the present inventors or the patent applicant that such documents or devices in any way form part of the common general knowledge in the art.

### Context

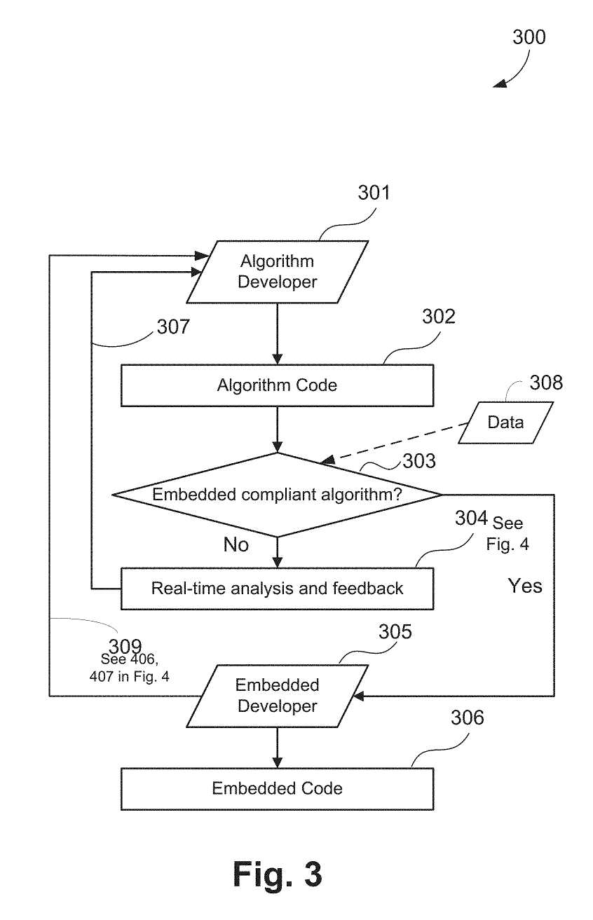

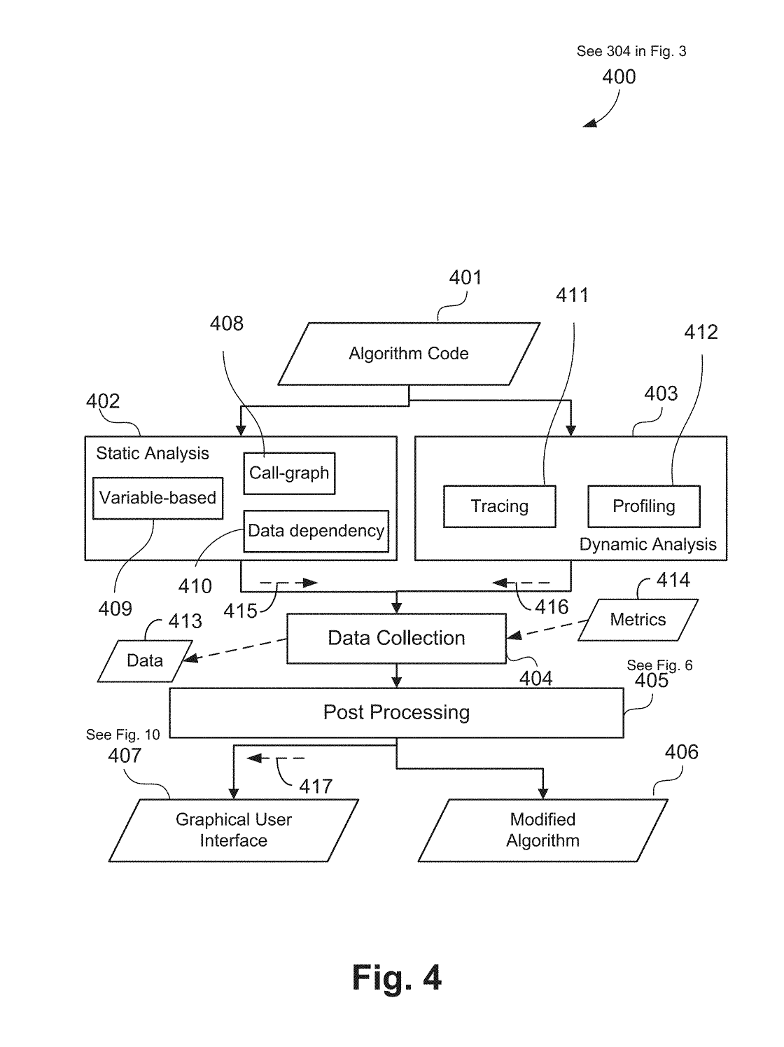

FIG. 3 depicts an example of a GAD process flow 300. An algorithm developer 301 creates an algorithm software code 302, which is then checked in real-time for embedded compliance in a step 303 based upon pre-defined embedded compliance information 308 For example, the information 308 can direct the step 303 to check the software algorithm code 302 for any hardware unfriendly code patterns, such as recursion and pointer re-assignments. Other examples of hardware unfriendly code patterns include code in which the algorithm software code 302 requires a memory space which exceeds the available memory space in the embedded hardware, or code in which the algorithm software code 302 would consume more gates than are available if it is to be generated as a hardware unit.

If the algorithm 302 is found not to be “hardware friendly” in the step 303, a real-time analysis is performed by a step 304 on different metrics of the algorithm to provide feedback, depicted by an arrow 307, to the algorithm developer 301. The feedback 307 provides information about possible improvements to the code 302 and the associated benefits. The feedback 307 assists the algorithm developer 301 to understand the algorithm software code 302 from the embedded hardware perspective, and assists the algorithm developer 301 to update the code 302 for embedded compliance, while still meeting the requirements of the algorithm.

If on the other hand the algorithm software code 302 is found to be hardware friendly in the step 303, then the code 302 is passed to an embedded developer 305 for further improvements in order to create embedded code 306.

If the embedded developer 305 nonetheless finds issues in the algorithm software code updated 302 which require modification in order to ensure hardware compatibility, the updated algorithm software code 302 is returned, as depicted by an arrow 309, to the algorithm developer 301 for modification and verification.

It is noted that the objective of the illustrated GAD flow is not to create a fully compliant embedded code (ie one in which the updated algorithm software code 302 is never returned as depicted by an arrow 309 to the algorithm developer 301 for modification and verification), but to provide a better algorithm software code 302 which is quite close to the desired embedded code 306, resulting in fewer iterations 309 between the algorithm developer 301 and the embedded developer 305.

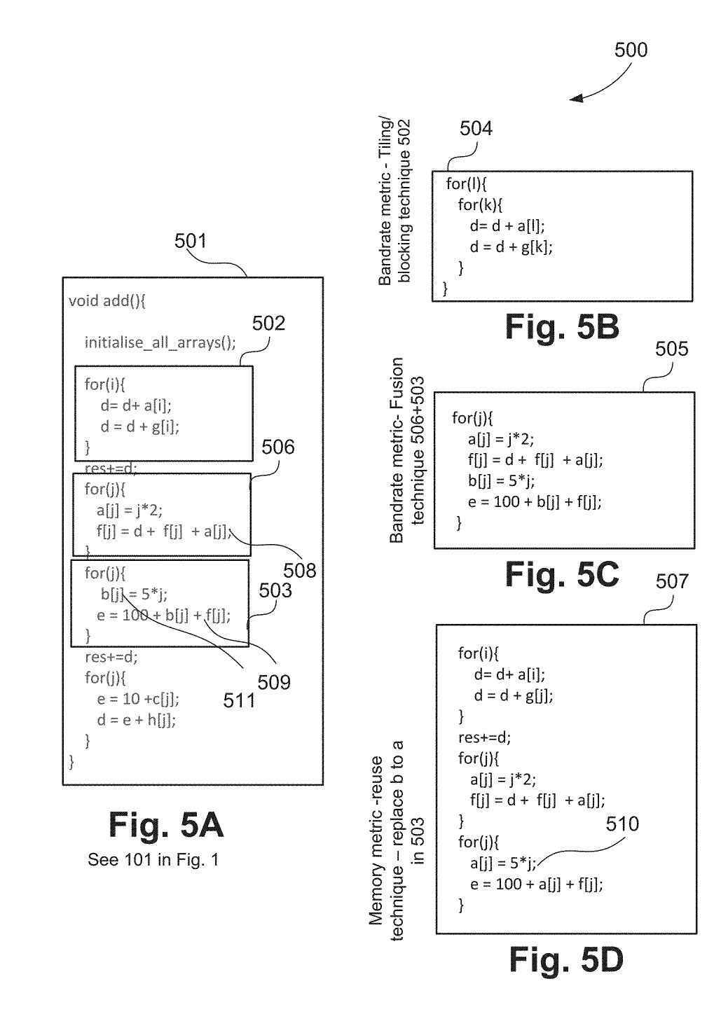

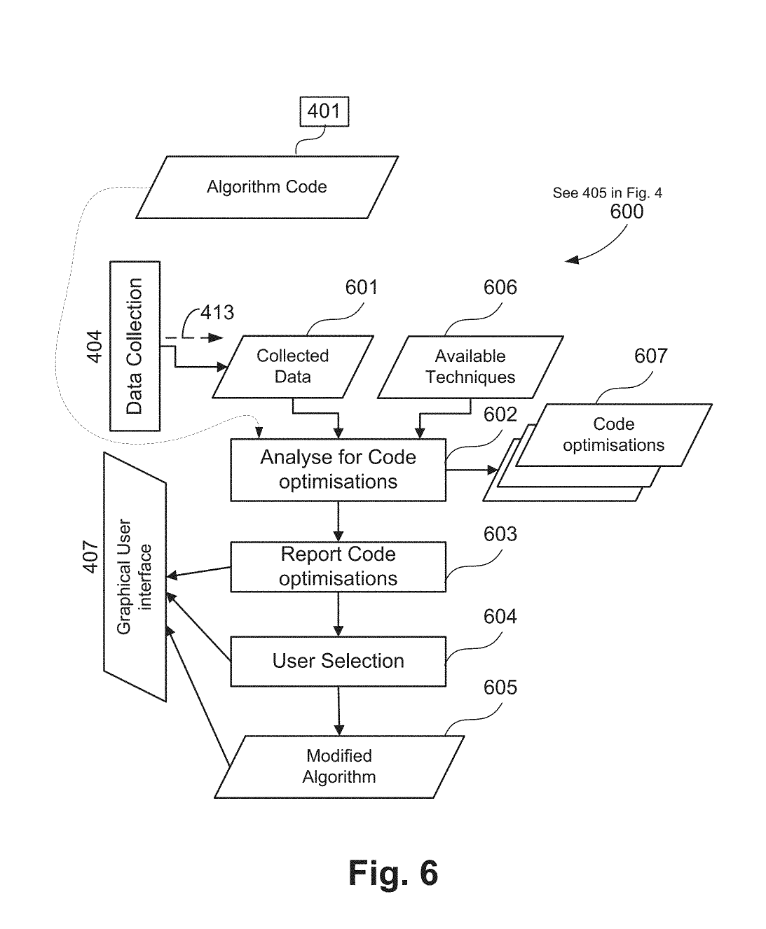

FIG. 4 depicts the real-time analysis and feedback process 304 in more detail in an example flow 400 in which algorithm software code 401 is analysed to generate (i) feedback information 417 for display on a graphical user interface 407, and (ii) possible modifications 406 to the algorithm software code 401 in the form of a snippet of modified code. The snippet of the modified code can be either a partial pseudo code or the actual optimised code of the updated algorithm software code 401.

The algorithm software code 401 is separately analysed in a Static Analysis step 402 and a Dynamic Analysis step 403.

The static analysis step 402 is performed for variables within the algorithm software code 401 using a variable-based static analysis process 409. Possible variable-based static analysis processes include (i) analysing program points based on compiler interpretations of the software code 401 and/or (ii) analysing statements in the software code 401. Variable-based static analysis is used, for example, to find the variables used in a function in order to identify the usage, sizes and types of the variables.

Other examples of static analysis can include a call-graph based analysis process 408 which is used to find dependencies between functions and a data dependency analysis process 410 to determine data dependency between code segments in order to find data transfers. Note that static analysis is further utilised to tag algorithm software code segments (process is not shown) to assist dynamic analysis.

Examples of dynamic analysis sub-processes in the dynamic analysis process 403 can include (i) a tracing process 411 to collect event outputs and timing details during the execution of the algorithm software code 401, and (ii) a profiling process 412 to find load and size information. The tracing process 411 can tag the algorithm software code 401 during function entry and exits to capture the code timings, and the profiling process 412 can determine execution cycles of functions in the algorithm software code 401.

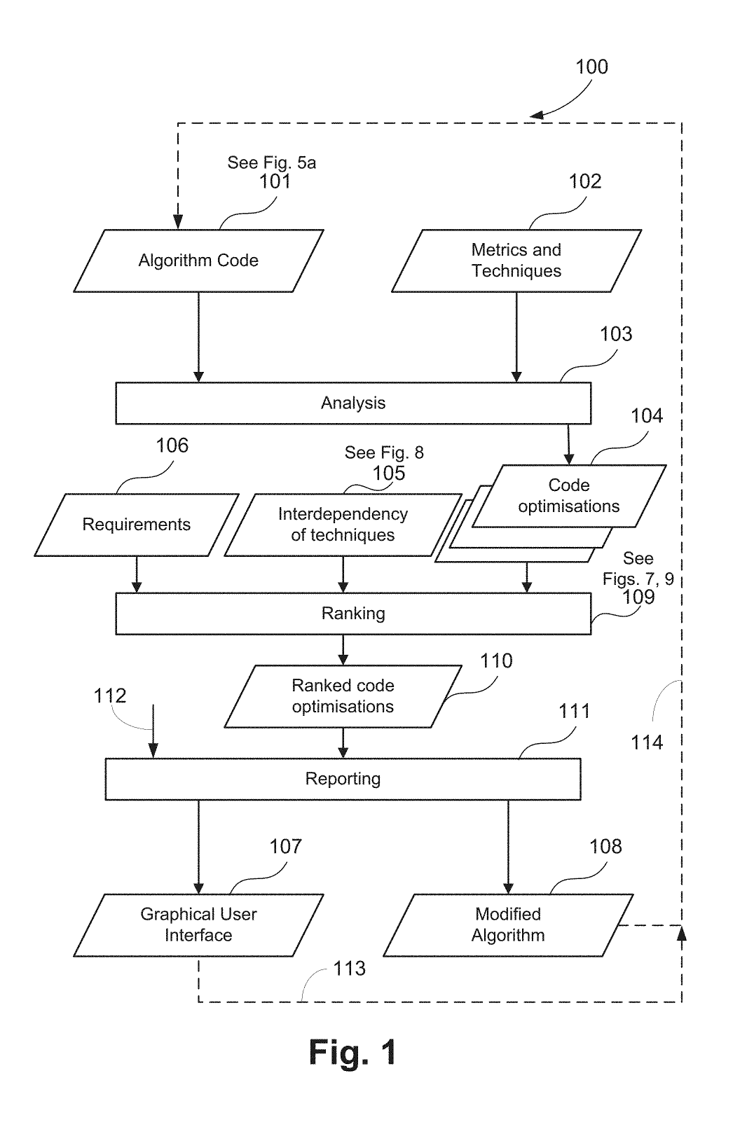

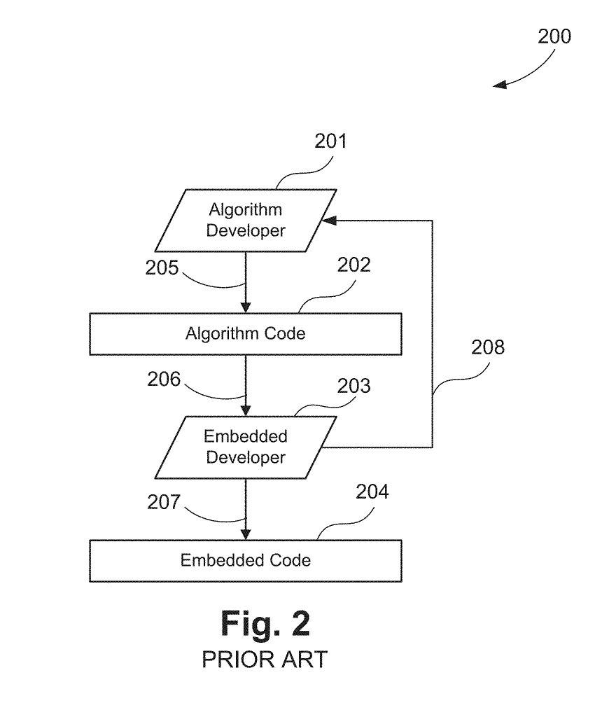

Once the static analysis 402 and the dynamic analysis 403 have been performed on the algorithm software code 401, data 413 is collected in a data collection step 404, based on specified metrics 414 (from 102 in FIG. 1), for post processing in a step 405. For example, if dynamic memory variations is a specified metric 414, then information 415 such as memory sizes of each function are collected from the static analysis step 402, and information 416 such as function entry and exit times are collected from the dynamic analysis step 403 to form part of the data 413 which is used in order to generate the dynamic memory variations (i.e., memory consumption of the algorithm software code over time) using the post processing step 405.

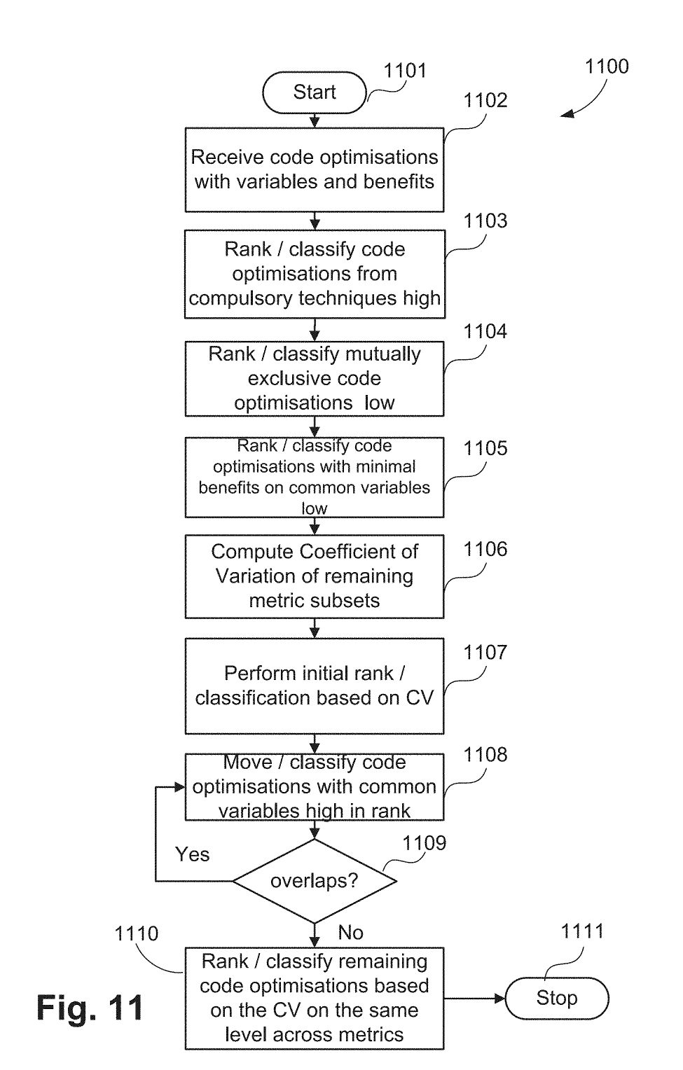

The post processing step 405 can also be used to find code optimisations as described hereinafter in more detail with reference to FIG. 6. Post processed data 417 is displayed in an interactive graphical user interface 407, described hereinafter in more detail with reference to FIGS. 10A-10C. Post processed data in the form of the modified algorithm 406, based on the selection of the algorithm developer in step 604, is output as a sample code snippet, where the sample code snippet could be a pseudo code of the modified algorithm or completely regenerated code of the algorithm 406.

FIG. 6 illustrates an example of the post processing step in 405. Data 601 (also see 413 in FIG. 4) which has been collected by the data collection process 404, and information 606 describing (i) available techniques such as loop fusion, loop tiling and data merging techniques for the band rate metric, and (ii) data reuse and data reduction techniques for the memory consumption metric, are used as inputs to analyse the algorithm software code 401 in an analysis step 602.

The analysis step 602 produces different code optimisations 607 (also referred to as “software code optimisations”) based on the applied techniques 606. The term “code optimisation” refers to an optimised way of re-writing the given algorithm software code 401 or specific portions of the algorithm software code 401 for hardware friendliness. A code optimisation includes the technique used and its' quantified and estimated benefit. For example, if replacing a variable ‘a’ with a variable ‘b’ using the data reuse technique provides a benefit of 100 bytes, then the code optimisation in question can be represented as “a,b—100”.

In another example, if fusing a “for loop” accessing arrays ‘x’ and ‘y’ provides a benefit of 1000 memory accesses, then the optimisation in question is represented as “x,y—1000”.

The code optimisations 607 are reported in a step 603 via the graphic user interface 407.

The algorithm developer 301 is interactively allowed to select, in a step 604, certain code optimisations, from the code optimisations displayed on the GUI 407, for exploration purposes, and each of the aforementioned selections result in display of an associated modified algorithm 605.

The IBR arrangements address common hardware friendly issues across different hardware platforms, rather than being specific to one or more platforms. For example, the IBR arrangements are configured to explore the amount of memory and gates required, rather than the specific type of memory and gate required.

Ranking unrelated code optimisations for quicker and sensible exploration is critical for improving the algorithm software code for hardware friendliness in a systematic fashion. This greatly enhances the efficiency of exploring code optimisations to create embedded code such as 204 from algorithm software code such as 202.

Finding either (a) the best set of code optimisations for different requirements 106, one such requirement being to identify code optimisations which maximise benefits across as many metrics as possible, or (b) code optimisations which are of criticality for the algorithm developer or hardware friendliness, reflecting the priorities of metrics, or (c) code optimisations which are of relative importance based on weights, is time consuming and tedious.

Due to the complexity of the algorithm and the level of analysis, where analysis of the code is performed with granularity at the “variable” level, using static analysis and dynamic analysis for many different metrics, the number of possible code optimisations can be quite large based on the complexity of the algorithm software code.

This large number of possible code optimisations requires user friendly reporting of the code optimisations so that the user can easily explore the optimisations for possible improvements to the algorithm.

In order to provide easy to understand exploration, a ranking scheme is necessary to rank the resultant code optimisations, based on the selected requirement, so that they can be displayed in the graphical user interface, for efficient exploration. The disclosed IBR arrangements provide the aforementioned ranking of the code optimisations based on the requirements 106.

While the present description describes the IBR arrangement at the level of “variable” granularity, other levels of granularity such as code block granularity can equally be used

### Overview of the IBR Arrangement

FIG. 1 depicts a schematic flow diagram 100 for the disclosed IBR arrangement. The disclosed IBR method can be used either with a complete software algorithm code 101, or with a section of the code 101, in order to assist the algorithm developer to provide a better algorithm software code 101 which is quite close to the desired embedded code, resulting in fewer iterations between the algorithm developer and the embedded developer.

Algorithm software code 101 and different hardware metrics and code optimisation techniques 102 are provided as inputs to an algorithm analysis process 103. Examples of hardware metrics 102 include memory consumption, bandrate (number of memory accesses), complexity and parallelisation. Examples for code optimisation techniques 102 (also referred to as techniques) include loop tiling and loop fusion for the bandrate metric and, data reuse and data reduction for the memory consumption metric.

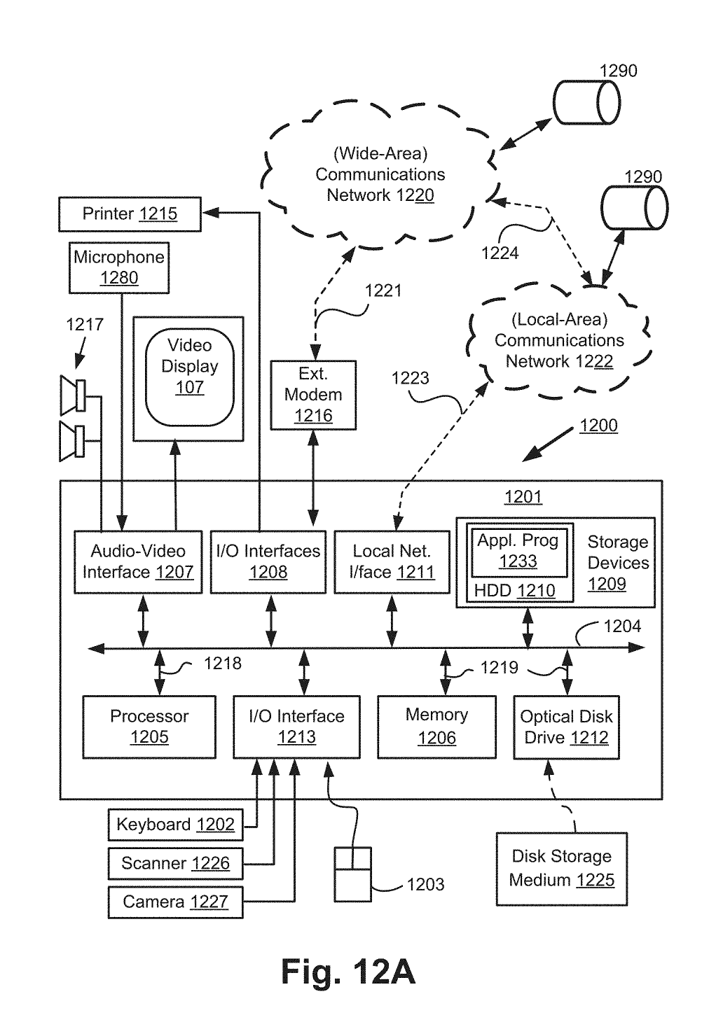

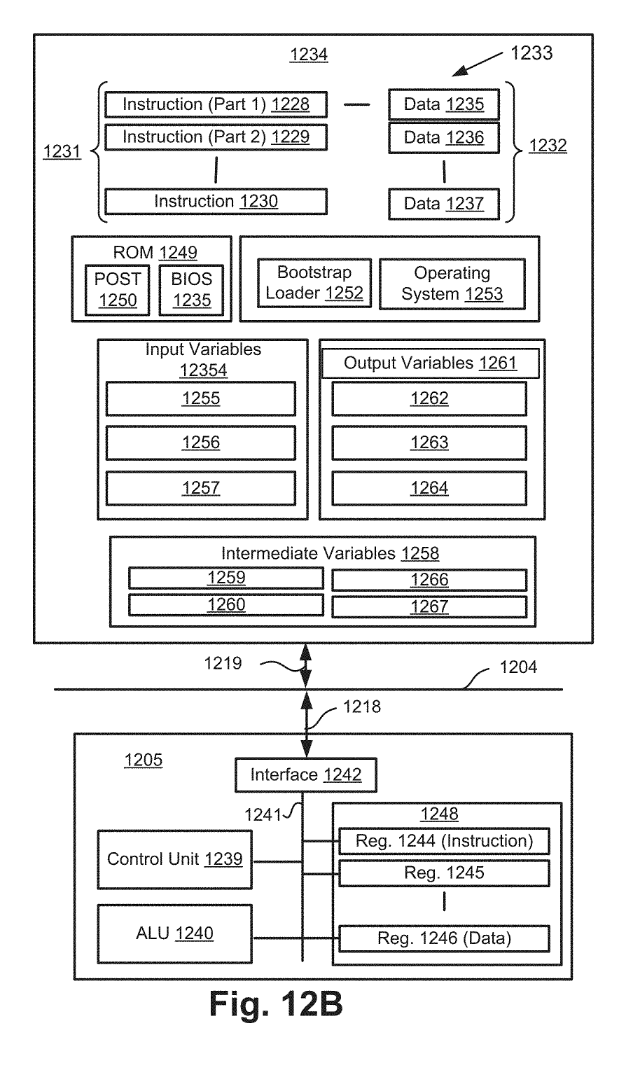

An analysis step 103, performed by a processor 1205 directed by a IBR software application 1233, described hereinafter in more detail with reference to FIGS. 12A and 12B, is invoked to analyse the algorithm software code 101 for the specified metrics and techniques 102. Based on the nature of the algorithm software code 101 and the specified optimisation techniques 102, code optimisations 104 are found as a result of the analysis 103, the code optimisations 104 characterising modifications to the software code that modify the associated hardware resource usage.

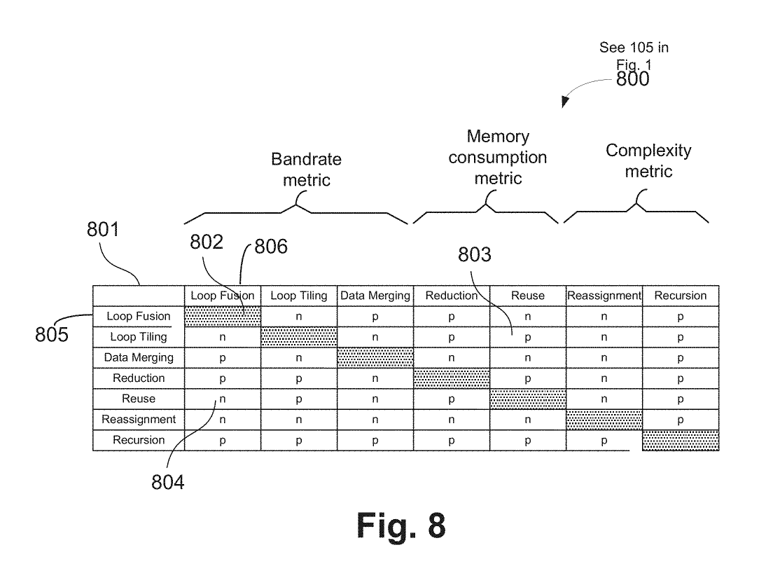

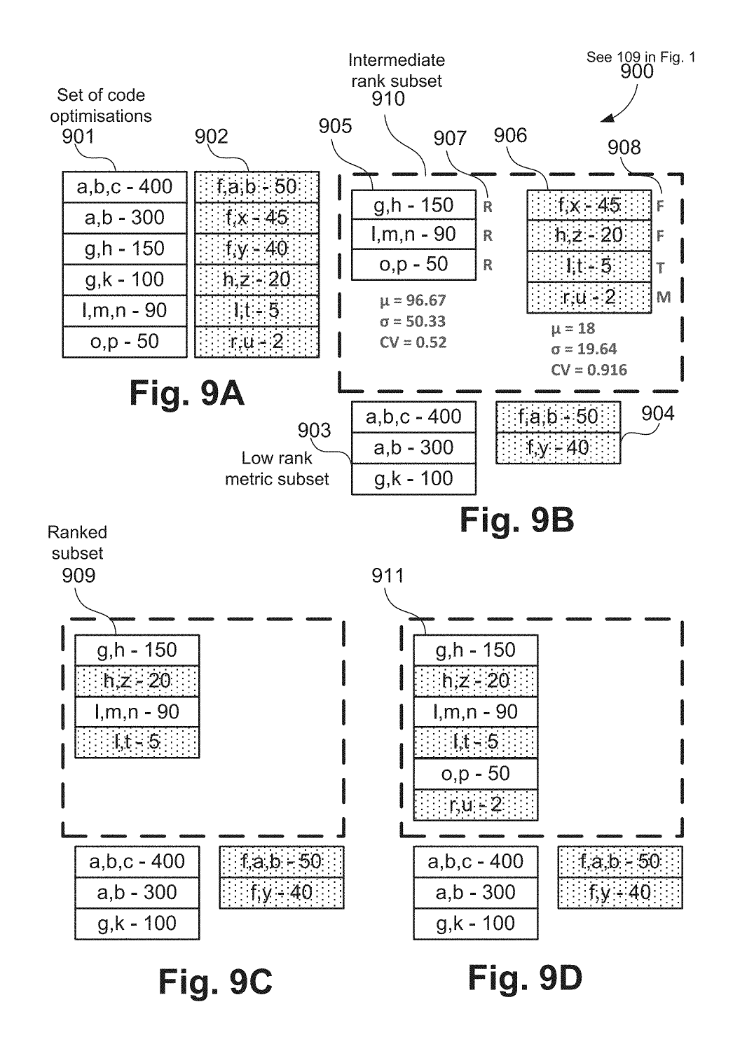

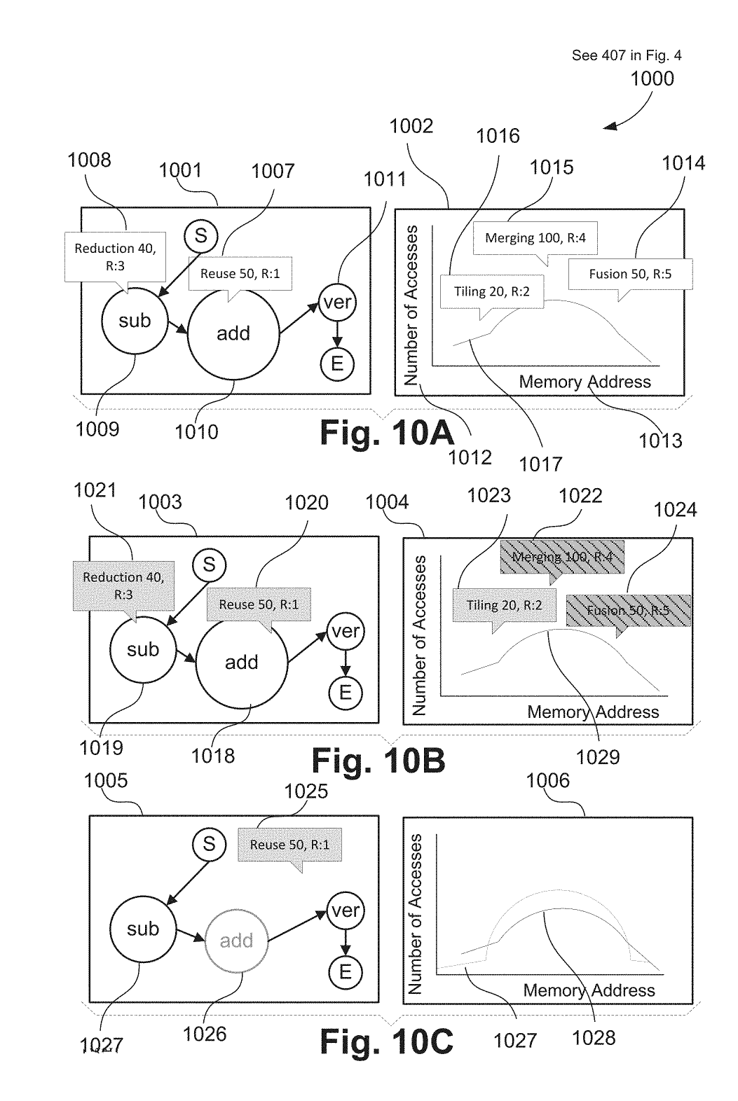

Given the code optimisations 104, as well as interdependencies between code optimisation techniques 105 (described hereinafter in more detail with reference to FIG. 8) and requirements 106, a ranking step 109 (described hereinafter in more detail with reference to FIGS. 9A-9D) produces a ranked set 110 of the code optimisations 104. The requirements are defined as user preferences, where the algorithm developer might want to rank the top alternatives which have the largest benefits across as many metrics as possible, or might want to rank the top alternatives which have highest benefits for bandrate metric, for example.

The interdependency 105 between techniques 102 is specified by pre-determined relationships between the specified code optimisation techniques 102, where the relationships are either determined by experimentation or specified by definition. For example, the definition of a loop merging technique will combine variables from multiple loops, where the definition of the variable reuse technique would require the loops to be still separate, creating a mutually exclusive relationship between these two techniques.

A detailed example of the interdependency 105 of techniques 102 is presented in a table 800 in FIG. 8. The ranking step 109, performed by a processor 1205 directed by a IBR software application 1233, is described in more detail using an example in FIGS. 9A-9D. The ranking step 109 assigns ranks to each of the code optimisations 104.

Based upon a user preference 112, a reporting step 111, performed by a processor 1205 directed by a IBR software application 1233, then presents the ranked code optimisations 110 on the graphical user interface 107. For example, the user can request the ten best code optimisations for exploration, in which event the reporting step 111 presents the first ten code optimisations in the ranked set 110. The reporting step 111 also constructs the modified algorithm 108, based on chosen code optimisation or code optimisations, and snippets of the modified algorithm will be output to assist the algorithm developer in modifying the software algorithm code. The presentation of the ranked code optimisations 110 on the graphical user interface 107 and provision of the modified algorithm 108 provide feedback 113, 114 to the algorithm developer (not shown) enabling the algorithm developer to modify the algorithm code 101 to incorporate the selected code optimisations to thereby form the modified algorithm code 108. The code snippet is output for the selected code optimisation, after the algorithm developer has explored the best set of code optimisations displayed. Note that the code snippets are an indication of the modifications required to the algorithm and may not be the entire rewritten algorithm code.

FIGS. 12A and 12B depict a general-purpose computer system 1200, upon which the various IBR arrangements described can be practiced.

As seen in FIG. 12A, the computer system 1200 includes: a computer module 1201; input devices such as a keyboard 1202, a mouse pointer device 1203, a scanner 1226, a camera 1227, and a microphone 1280; and output devices including a printer 1215, a Graphical ser Interface (GUI) display device 107 and loudspeakers 1217. An external Modulator-Demodulator (Modem) transceiver device 1216 may be used by the computer module 1201 for communicating to and from a communications network 1220 via a connection 1221. The communications network 1220 may be a wide-area network (WAN), such as the Internet, a cellular telecommunications network, or a private WAN. Where the connection 1221 is a telephone line, the modem 1216 may be a traditional “dial-up” modem. Alternatively, where the connection 1221 is a high capacity (e.g., cable) connection, the modem 1216 may be a broadband modem. A wireless modem may also be used for wireless connection to the communications network 1220.

The computer module 1201 typically includes at least one processor unit 1205, and a memory unit 1206. For example, the memory unit 1206 may have semiconductor random access memory (RAM) and semiconductor read only memory (ROM). The computer module 1201 also includes an number of input/output (I/O) interfaces including: an audio-video interface 1207 that couples to the video display 107, loudspeakers 1217 and microphone 1280; an I/O interface 1213 that couples to the keyboard 1202, mouse 1203, scanner 1226, camera 1227 and optionally a joystick or other human interface device (not illustrated); and an interface 1208 for the external modem 1216 and printer 1215. In some implementations, the modem 1216 may be incorporated within the computer module 1201, for example within the interface 1208. The computer module 1201 also has a local network interface 1211, which permits coupling of the computer system 1200 via a connection 1223 to a local-area communications network 1222, known as a Local Area Network (LAN). As illustrated in FIG. 12A, the local communications network 1222 may also couple to the wide network 1220 via a connection 1224, which would typically include a so-called “firewall” device or device of similar functionality. The local network interface 1211 may comprise an Ethernet circuit card, a Bluetooth® wireless arrangement or an IEEE 802.11 wireless arrangement; however, numerous other types of interfaces may be practiced for the interface 1211.

The I/O interfaces 1208 and 1213 may afford either or both of serial and parallel connectivity, the former typically being implemented according to the Universal Serial Bus (USB) standards and having corresponding USB connectors (not illustrated). Storage devices 1209 are provided and typically include a hard disk drive (HDD) 1210. Other storage devices such as a floppy disk drive and a magnetic tape drive (not illustrated) may also be used. An optical disk drive 1212 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 1200.

The components 1205 to 1213 of the computer module 1201 typically communicate via an interconnected bus 1204 and in a manner that results in a conventional mode of operation of the computer system 1200 known to those in the relevant art. For example, the processor 1205 is coupled to the system bus 1204 using a connection 1218 Likewise, the memory 1206 and optical disk drive 1212 are coupled to the system bus 1204 by connections 1219. Examples of computers on which the described arrangements can be practised include IBM-PC's and compatibles, Sun Sparcstations, Apple Mac™ or like computer systems.

The IBR method may be implemented using the computer system 1200 wherein the processes of FIGS. 1, 3, 4, 6, 11, 13 and 14, to be described, may be implemented as one or more software application programs 1233 executable within the computer system 1200. In particular, the steps of the IBR method are effected by instructions 1231 (see FIG. 12B) in the IBR software 1233 that are carried out within the computer system 1200. The software instructions 1231 may be formed as one or more code modules, each for performing one or more particular tasks. The software may also be divided into two separate parts, in which a first part and the corresponding code modules performs the IBR methods and a second part and the corresponding code modules manage a user interface between the first part and the user.

The IBR software may be stored in a computer readable medium, including the storage devices described below, for example. The software is loaded into the computer system 1200 from the computer readable medium, and then executed by the computer system 1200. A computer readable medium having such software or computer program recorded on the computer readable medium is a computer program product. The use of the computer program product in the computer system 1200 preferably effects an advantageous apparatus for performing the IBR methods.

The software 1233 is typically stored in the HDD 1210 or the memory 1206. The software is loaded into the computer system 1200 from a computer readable medium, and executed by the computer system 1200. Thus, for example, the software 1233 may be stored on an optically readable disk storage medium (e.g., CD-ROM) 1225 that is read by the optical disk drive 1212. A computer readable medium having such software or computer program recorded on it is a computer program product. The use of the computer program product in the computer system 1200 preferably effects an apparatus for implementing the IBR arrangements.

In some instances, the application programs 1233 may be supplied to the user encoded on one or more CD-ROMs 1225 and read via the corresponding drive 1212, or alternatively may be read by the user from the networks 1220 or 1222. Still further, the software can also be loaded into the computer system 1200 from other computer readable media. Computer readable storage media refers to any non-transitory tangible storage medium that provides recorded instructions and/or data to the computer system 1200 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 1201. Examples of transitory or non-tangible computer readable transmission media that may also participate in the provision of software, application programs, instructions and/or data to the computer module 1201 include radio or infra-red transmission channels as well as a network connection to another computer or networked device, and the Internet or Intranets including e-mail transmissions and information recorded on Websites and the like.

The second part of the application programs 1233 and the corresponding code modules mentioned above may be executed to implement one or more graphical user interfaces (GUIs) to be rendered or otherwise represented upon the display 107. Through manipulation of typically the keyboard 1202 and the mouse 1203, a user of the computer system 1200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1217 and user voice commands input via the microphone 1280.

FIG. 12B is a detailed schematic block diagram of the processor 1205 and a “memory” 1234. The memory 1234 represents a logical aggregation of all the memory modules (including the HDD 1209 and semiconductor memory 1206) that can be accessed by the computer module 1201 in FIG. 12A.

When the computer module 1201 is initially powered up, a power-on self-test (POST) program 1250 executes. The POST program 1250 is typically stored in a ROM 1249 of the semiconductor memory 1206 of FIG. 12A. A hardware device such as the ROM 1249 storing software is sometimes referred to as firmware. The POST program 1250 examines hardware within the computer module 1201 to ensure proper functioning and typically checks the processor 1205, the memory 1234 (1209, 1206), and a basic input-output systems software (BIOS) module 1251, also typically stored in the ROM 1249, for correct operation. Once the POST program 1250 has run successfully, the BIOS 1251 activates the hard disk drive 1210 of FIG. 12A. Activation of the hard disk drive 1210 causes a bootstrap loader program 1252 that is resident on the hard disk drive 1210 to execute via the processor 1205. This loads an operating system 1253 into the RAM memory 1206, upon which the operating system 1253 commences operation. The operating system 1253 is a system level application, executable by the processor 1205, to fulfil various high level functions, including processor management, memory management, device management, storage management, software application interface, and generic user interface.

The operating system 1253 manages the memory 1234 (1209, 1206) to ensure that each process or application running on the computer module 1201 has sufficient memory in which to execute without colliding with memory allocated to another process. Furthermore, the different types of memory available in the system 1200 of FIG. 12A must be used properly so that each process can run effectively. Accordingly, the aggregated memory 1234 is not intended to illustrate how particular segments of memory are allocated (unless otherwise stated), but rather to provide a general view of the memory accessible by the computer system 1200 and how such is used.

As shown in FIG. 12B, the processor 1205 includes a number of functional modules including a control unit 1239, an arithmetic logic unit (ALU) 1240, and a local or internal memory 1248, sometimes called a cache memory. The cache memory 1248 typically includes a number of storage registers 1244-1246 in a register section. One or more internal busses 1241 functionally interconnect these functional modules. The processor 1205 typically also has one or more interfaces 1242 for communicating with external devices via the system bus 1204, using a connection 1218. The memory 1234 is coupled to the bus 1204 using a connection 1219.

The IBR application program 1233 includes a sequence of instructions 1231 that may include conditional branch and loop instructions. The program 1233 may also include data 1232 which is used in execution of the program 1233. The instructions 1231 and the data 1232 are stored in memory locations 1228, 1229, 1230 and 1235, 1236, 1237, respectively. Depending upon the relative size of the instructions 1231 and the memory locations 1228-1230, a particular instruction may be stored in a single memory location as depicted by the instruction shown in the memory location 1230. Alternately, an instruction may be segmented into a number of parts each of which is stored in a separate memory location, as depicted by the instruction segments shown in the memory locations 1228 and 1229.

In general, the processor 1205 is given a set of instructions which are executed therein. The processor 1205 waits for a subsequent input, to which the processor 1205 reacts to by executing another set of instructions. Each input may be provided from one or more of a number of sources, including data generated by one or more of the input devices 1202, 1203, data received from an external source across one of the networks 1220, 1202, data retrieved from one of the storage devices 1206, 1209 or data retrieved from a storage medium 1225 inserted into the corresponding reader 1212, all depicted in FIG. 12A. The execution of a set of the instructions may in some cases result in output of data. Execution may also involve storing data or variables to the memory 1234.

The disclosed IBR arrangements use input variables 1254, which are stored in the memory 1234 in corresponding memory locations 1255, 1256, 1257. The IBR arrangements produce output variables 1261, which are stored in the memory 1234 in corresponding memory locations 1262, 1263, 1264. Intermediate variables 1258 may be stored in memory locations 1259, 1260, 1266 and 1267.

Referring to the processor 1205 of FIG. 12B, the registers 1244, 1245, 1246, the arithmetic logic unit (ALU) 1240, and the control unit 1239 work together to perform sequences of micro-operations needed to perform “fetch, decode, and execute” cycles for every instruction in the instruction set making up the program 1233. Each fetch, decode, and execute cycle comprises:
a fetch operation, which fetches or reads an instruction 1231 from a memory location 1228, 1229, 1230;
a decode operation in which the control unit 1239 determines which instruction has been fetched; and
an execute operation in which the control unit 1239 and/or the ALU 1240 execute the instruction.

Thereafter, a further fetch, decode, and execute cycle for the next instruction may be executed. Similarly, a store cycle may be performed by which the control unit 1239 stores or writes a value to a memory location 1232.

Each step or sub-process in the processes of FIGS. 1, 3, 4, 6, 11, 13 and 14 is associated with one or more segments of the program 1233 and is performed by the register section 1244, 1245, 1247, the ALU 1240, and the control unit 1239 in the processor 1205 working together to perform the fetch, decode, and execute cycles for every instruction in the instruction set for the noted segments of the program 1233.

### EMBODIMENT 1

FIGS. 5A-5D show an example of metrics and code optimisation techniques to generate hardware friendly algorithms without the user specifying any preference of metrics. This arrangement aims to optimise across as many metrics as possible.

FIG. 5A shows an algorithm software code 501 having three ‘for’ loops 502, 506 and 503 which can be improved for hardware friendliness.

FIG. 5B shows an improved ‘for’ loop code optimisation 504 of an original ‘for’ a loop 502, in which a tiling or blocking code optimisation technique has been used to improve the bandrate metric. A ‘for’ loop will henceforth be referred to as a “loop” in this specification. The ‘bandrate’ is defined as the rate at which an external memory (such as Double Data Rate (DDR) memory) is accessed by a System-on-Chip (SoC), where it is critical to minimise the bandrate to gain better performance and power. The tiling code optimisation breaks the loop 502, which was iterating on a row ‘i’, into a tile ‘I’ and ‘k’ as shown in 504. Such tiling improves the locality of the data being accessed, and hence generates more hits, either in a cache or a scratchpad, compared to accessing the entire row, in which previous data will be lost when fetching the next row, causing more misses. Hence the benefit of 504 compared to 502 will be approximately (I)x(k) memory accesses, with reference to variables of interest ‘a’ and ‘g’, since variable ‘d’ is acting as a temporary variable. Hence the code optimisation 504 will be referred to as ‘a,g—Ixk’. It is worth noting that the temporary variable ‘d’ can be also included in the code optimisation if it significantly affects the technique in consideration, which is tiling in this example.

FIG. 5C shows a code optimisation 505 using a loop fusion technique, to improve the bandrate metric, applied to loops 506 and 503. The original loops in 506 and 503 have statements 508 and 509 where an array ‘f’ is written and read separately. Once the array ‘f’ is processed and written in the loop 506, the same set of elements in ‘f’ are read again in the loop 503. By the time ‘f’ is accessed in 503, the written values of ‘f’ in 506 will not be available in the cache or scratchpad and hence will cause more misses, due to the other operations between the read 509 and write 508 statements of ‘f’. The fusion code optimisation technique optimises these scenarios to reduce such misses, by fusing loops so that the write and read can be performed without requiring a miss in cache or scratchpad. As shown in the code optimisation 505 the fusion technique combines the loops 506 and 503 into a single loop, so that the statements 508 and 509 are executed next to each other for the same element in the loop. This probably keeps the written elements of ‘fj’ in the cache when ‘fj’ is read in statement 509. This code optimisation example can be referred to as ‘a,b,f—50’, where 50 is the estimated number of accesses saved (i.e., benefit) due to fusion and the primary variables affecting this benefit are ‘a’, ‘b’ and ‘f’ in this example.

FIG. 5D shows a code optimisation 507 for improving the memory metric using a reuse code optimisation technique. The reuse technique attempts to reuse variables based on their liveliness in the source code. Liveliness considers, for each program point, the variables that may be potentially read before their next write, that is, the variables that are alive at the exit from each program point. A variable is live if it holds a value that may be needed in the future.

The code optimisation 507 shows that the statement 509 in the code fragment 503 is replaced with a statement 510 in 507. Since the variable ‘a’ is not used beyond loop 506 in the code fragment 501, and the variable ‘b’ is only used in the loop 503, the variable ‘b’ can be replaced with the variable ‘a’ so that the variable ‘a’ can be used as both the variable ‘a’ and the variable ‘b’. Such replacement will improve the required memory size by the size of variable ‘b’, since the variable ‘b’ is not needed anymore in the code optimisation 507. This code optimisation is referred to as ‘a,b—20’ where the variable ‘b’ is of size 20 bytes (which is a benefit) and the variables of interest are ‘a’ and ‘b’.

Similarly the specified code optimisation techniques for different hardware metrics are identified using the benefit and the variables of interest. The amount of the benefit and the identification of the variables are dependent upon the analysis approach used. For example, a static analysis will identify all the variables inside a “for loop” as variables of interest with static benefits, but a dynamic analysis will allow finding the critical variables of interest with targeted benefits for the representative input data.

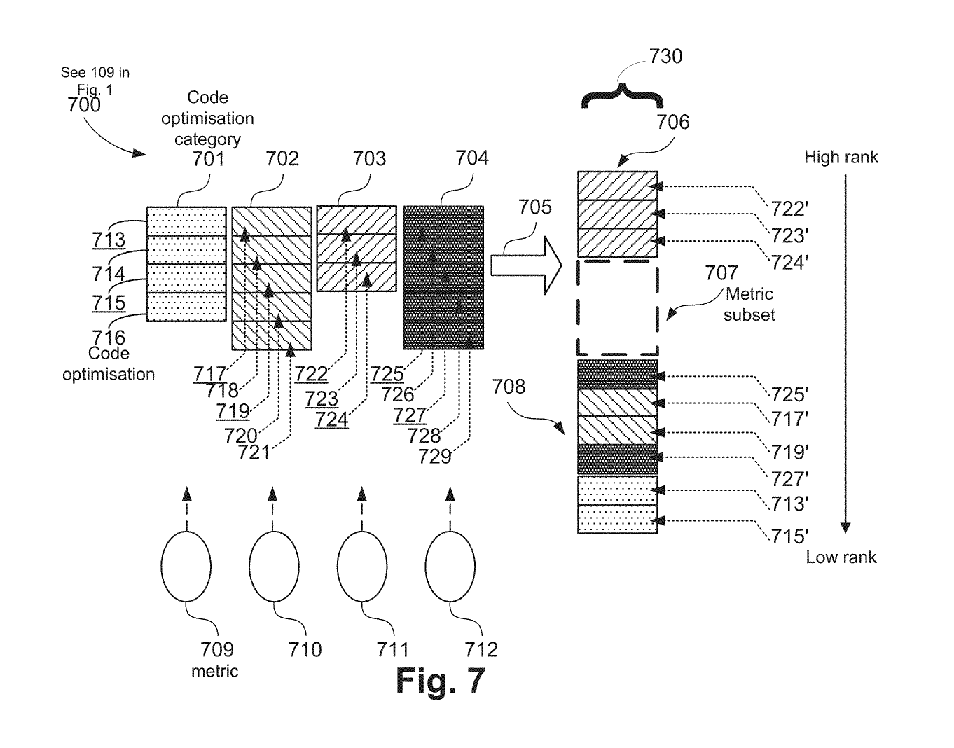

Once the analysis 103 has created the code optimisations 104 for a given algorithm software code 101, the ranking step 109 utilises the benefits and the variables of interests to rank the code optimisations, as described hereinafter in more detail with reference to FIGS. 7 and 9.

FIG. 7 illustrates an example of the overall ranking concept used in the disclosed IBR arrangements.

In the described IBR arrangements, code optimisations are referred to as being either “complementary” (this also being referred to as having “positive interdependency”) or “mutually exclusive” (this also being referred to as having negative interdependency), as described hereinafter in more detail with reference to FIG. 8 which depicts optimisation techniques which are pairwise complementary or mutually exclusive. The term “pairwise” reflects the fact that FIG. 8 depicts relationships between pairs of optimisation techniques, each technique being associated with a particular metric. Thus for example the loop fusion code optimisation technique is used in relation to the band rate metric (ie the number of memory accesses) and use of the aforementioned technique yields a benefit whose units of measurement are “estimated number of accesses saved”. Similarly, the memory reuse technique is used in relation to the memory consumption metric (ie the amount of memory used) and use of the aforementioned technique yields a benefit whose units of measurement are “bytes of memory use saved”. A pair of complementary code optimisation techniques can be used together to improve the algorithm code in question, wherein each of the complementary code optimisation techniques provides a corresponding code optimisation which has a benefit in the units associated with the corresponding metric. In contrast, a pair of mutually exclusive code optimisation techniques cannot be used together.

The overall objective is (i) to rank code optimisations which are complementary, and thus more beneficial, as having higher ranks, and (ii) to rank code optimisations which are mutually exclusive with minimal benefits as having lower ranks. This has the effect of classifying complementary code optimisations as belonging to a higher rank metric subset, and mutually exclusive code optimisations as belonging to a lower rank metric subset. This allows sensible reporting to the algorithm developer for easier exploration in considering the code optimisations which are of high value. In the example shown in FIG. 7, the analysis is performed for four different metrics depicted as 709-712 which results in four different code optimisation categories 701, 702, 703 and 704 (also referred to as sets of code optimisations), respectively comprising multiple code optimisations 713-716, 717-721, 722-724, and 725-729 possibly achieved using multiple code optimisation techniques.

Thus for example the metric 709 in one example is band rate, in which case the code optimisation category 701 is a band rate code optimisation category containing a code optimisation 714 which has been generated using a loop fusion code optimisation technique, and a code optimisation 716 which has been generated using a data merging technique.

The objective of the ranking process is to rank all of the code optimisations (713-716, 717-721, 722-724, and 725-729) by performing a ranking 705 to create the ranked set 730 of code optimisations. Typically the ranked set 730 of code optimisations is made up of a high-rank metric subset 706, a low-rank metric subset 708, and an intermediate rank metric subset 707.

The first step is to rank code optimisations of compulsory metrics 703 (ie 722-724) high (ie they are located at the high ranked metric subset 706 and designated by reference numerals 722′-724′). The reference numerals 722-724 have been underlined in FIG. 7 to indicate that these have been ranked at this stage. Compulsory code optimisations (ie code optimisations of compulsory metrics) are mandatory to execute the algorithm software code in an embedded hardware. For example, code patterns such as recursions and pointer reassignments, which are examples for the compulsory code optimisation techniques, have to be eliminated from the algorithm software code, since they are hardly supported in most embedded hardware, and require significant care if they are to be supported. In other words, recursive code patterns are a compulsory technique, which needs to be either eliminated or should be accorded the highest priority.

The second step is to find code optimisations which are mutually exclusive and rank them low, as shown at the low-ranked metric subset 708. In the example shown in FIG. 7 code optimisation techniques 725, 717, 719, 727, 713 and 715 are determined to be mutually exclusive, and are located at 708 and depicted by corresponding reference numerals 725′, 717′, 719′, 727′, 713′ and 715′. The reference numerals 725, 717, 719, 727, 713 and 715 have been underlined in FIG. 7 to indicate that these have been ranked at this stage. The property of mutual exclusiveness is identified by utilising the interdependency information of the techniques 105 (described hereinafter in more detail with reference to FIG. 8), where code optimisations with negative interdependency (ie pairs of code optimisation techniques whose entry in the table in FIG. 8 has an “n”) with overlaps in variables are considered mutually exclusive. In other words, code optimisations are mutually exclusive only when an “n” in the requisite cell of the table in FIG. 8 AND there are variable overlaps. A pair of code optimisation techniques are defined as having an overlap in variables (also referred to as common variables) if they have at least one common variable. Further details are provided in FIG. 8.

Once the low rank code optimisations (725′, 717′, 719′, 727′, 713′ and 715′) are found and located at the low rank metric subset 708, then the remaining code optimisation techniques (714, 716,718, 720, 721, 726, 728 and 729), which are not underlined in FIG. 7, are ranked into the intermediate rank metric subset 707 based on the interdependency of techniques 105 and the requirements 106. This has the effect of classifying these code optimisations as belonging to the intermediate rank metric subset. An example of this ranking process 700 is provided in FIGS. 9A-9D.

FIG. 8 shows an example interdependency table 800 of techniques. A top row and first column (805 and 806 respectively) list the considered code optimisation techniques across different metrics. The table 800 is a symmetric table reflecting the interdependency between pairs of code optimisation techniques and hence the diagonal slots such as 802 are invalid. The loop fusion technique, loop tiling technique and data merging techniques are related to the bandrate metric, where loop fusion and loop tiling are described in FIGS. 5A-5D and data merging is about merging multiple variables into structures if the multiple variables are mostly used together. The reuse and reduction techniques are related to the memory consumption metric, where reuse is explained in FIGS. 5A-5D and reduction is about separating elements of a structure into multiple variables to improve data locality, when the elements are hardly used as a combination in the algorithm software code. A number of examples of compulsory techniques include recursions and pointer reassignments are now described. For example, a function being recursively called should be eliminated for hardware friendliness by unrolling the function, which is a compulsory code optimisation technique. An example for reassignment (such as pointer reassignments) can be where multiple pointers pointing to the same variable. Such a pointer usage is not hardware friendly, hence require optimisation by separating the multiple pointers into multiple, explicit variables.

Note that there can be more metrics and techniques depending upon the nature of the embedded hardware optimisation. The value ‘n’ in a cell indicates that the intersecting code optimisation techniques have a negative interdependency, and ‘p’ indicates positive interdependency.

The negative interdependency refers to the two techniques being mutually exclusive and positive interdependency refers to two techniques being complimentary.

For example, the loop fusion and reuse are mutually exclusive hence have an ‘n’ interdependency as shown at 804. Since loop fusion merges loops together as illustrated in 505, the reuse technique, which requires loops to be separate for replacing variables as shown in 507 is mutually exclusive to the loop fusion. Likewise, the loop tiling and reuse techniques are complementary as shown in 803, where loop tiling separates the loop as tiles as shown in 504 which will complement replacing variables for reuse as shown in 507. Mutual exclusiveness is valid when there are common variables of interest across code optimisations with the two mutually exclusive techniques. If there are no common variables between two code optimisation techniques which are marked as “n” in the table, they are still considered as complementary. The idea being that both the code optimisation techniques can be applied together without affecting the functionality of the algorithm code. The interdependencies of code optimisations techniques are either set by design, or determined experimentally either using a set of representative algorithm software codes, or an algorithm software code with representative input data set.

FIGS. 9A-9D depict an example 900 to explain the ranking step 109 which uses the interdependency table of FIG. 8 (i.e., interdependency of techniques 105), the requirements 106 and the code optimisations 104 to achieve the overall ranking 700 and generate the ranked set 730 of code optimisation techniques. In particular, the ranking of code optimisation segments 707 and 708 are of most interest.

FIG. 9A shows 901 and 902 which are sets of code optimisations which respectively relate to different metrics such as memory consumption and bandrate. In this example neither of the sets of code optimisation techniques is found to be compulsory, and hence ranking for the intermediate rank metric subset 707 and the low rank metric subset 708 are required but ranking is not required for the high rank metric subset 706. This ranking example is based upon a requirement of having to find the best set of code optimisations which benefit as many metrics as possible. Hence a higher ranked code optimisation will have better benefits for the two metrics considered, compared to a lower ranked code optimisation.

FIG. 9B shows an initial ranking step where the code optimisations with common variables and/or which have negative interdependencies are marked as low ranks and moved to lower rank metric subsets 903 and 904 (these represent the segment 708 in FIG. 7). Due to the requirement of having to find the code optimisations which provide maximal benefit across multiple metrics, any code optimisation which has (i) common variables (either a partial or a full list of variables) and (ii) has a negative interdependency on their respective code optimisation techniques are pushed to low rank.

For example, the code optimisations ‘a,b,c—400’, ‘a,b—300’ and ‘f,a,b—50’ are pushed to the low rank metric subsets 903 and 904 because each of the aforementioned code optimisation technique has one or more of variables a, b and c. Code optimisations ‘g,k—100’ and ‘f,y—40’ are also pushed to the low rank metric subsets 903 and 904, since code optimisations with better benefits with common variables exist such as ‘g,h—150’ in metric 901 subset 905 and ‘f,x—45’ in metric 902 subset 906.

Except for the code optimisations which have the negative interdependency and common variables, as well the ones which provide better benefits, the remaining code optimisations are classified as belonging to the intermediate rank metric subset 910 (which represents the segment 707). The letter tags 907, 908 for the code optimisations in 910 refer to the type of code optimisation techniques associated with the respective code optimisations; ‘R’—reuse, ‘F’—loop fusion, ‘T’—loop tiling, ‘M’—data merging.

For each metric subset 905 and 906, a Correlation of Variation (CV)=σ/μ, is determined by calculating the mean (μ) and standard deviation (σ), of the benefits of the code optimisations in each metric subset. For example, the CV of the metric subset 905 based on the benefits 150, 90 and 50 are calculated as 0.52, which is 50.33/96.67. The mean is the average of 150, 90 and 50, that is 150+90+50=290/3=96.67, whereas the standard deviation is computed using the equation below.

S=√(Σ(X−M)²/(n−1))

where S is the standard deviation, X is the number, M is the mean and n is the number of elements. The difference between the number and the mean are squared and summed, and then divided by n−1 before it is operated with a square root. According to this equation and following the above example, the numbers 150, 90, 50 will be subtracted with mean 96.67 (150−96.67=53.33, 90−96.67=−6.67, 50−96.67=−46.67), squared (2844.09, 44.49, 2178.09) and summed (2844.09+44.49+2178.09=5066.67), then divided by 3−1=2 (5066.67/2=2533.33) to get the square root value 50.33.

Similarly the CV of the metric subset 906 based on the benefits 40, 20, 5, 2 are calculated as 0.916, which is 19.64/18. The CV value allow comparison of metrics with benefits having different units (e.g., number of accesses and memory size in bytes), while being able to provide an insight about the average degree in reduction of benefits within the metric subset. In general, the smaller the CV the smaller distance between benefits hence better when ranking.

Once the CV is computed, an initial ranking decision is made at the level of metric subsets. For example, the metric subset 905 is determined to have a higher rank compared to the metric subset 906, since the CV of 905 is smaller than the CV of 906. When the CV is lower, the degree of reduction between code optimisations will be smaller, and hence considered better to efficiently find the best set of code optimisations.

The next step is to find complementary code optimisations with common variables in the segment 910 (which relates to segment 707). As shown in a ranked subset 909, code optimisations with common variables ‘g,h—150’, ‘h,z—20’ and ‘l,m,n—90’, ‘l,t—5’ are ranked first, with the metric with lower CV provided with higher rank. That is, code optimisation ‘g,h—150’ and ‘l,m,n—90’ are ranked higher than ‘h,z—20’ and ‘l,t—5’ respectively. Note that the ranking further considers the absolute value of the benefit when deciding between different sets of common variables. For example, ‘g,h—150’ is ranked higher than ‘l,m,n—90’, since both of them are in same units and 150 is greater than 90.

Once the code optimisations with the common variables are ranked, the remaining code optimisations are ranked based on the computed CV, but at the same level across metrics. The level is defined as the order of code optimisations in terms of benefits. Respective code optimisations with highest benefits across multiple metrics are considered to be on the same level. For example in the ranked subset 911 the code optimisation ‘o,p—50’ is ranked before ‘r,u—2’. In this example, both ‘o,p—50’ and ‘r,u—2’ are on the same level. A similar ranking can be applied to code optimisations in the low rank metric subsets, such as 903 and 904, which is not shown. Note that the ranking process, especially the step in finding the initial ranking, will be different for a different requirement.

FIG. 11 illustrates a preferred method 1100 to rank code optimisations as explained using the example in FIGS. 9A-9D to satisfy the requirement of finding the best set of code optimisations which provide maximal benefit across as many metrics as possible.

The ranking process is specific to the algorithm code in question, and depends upon the interdependency table being used (such as the table depicted in FIG. 8), the associated benefits (eg the decrease in memory accesses), and the variables being considered (being the variables in the algorithm code).

The method 1100 starts at a step 1101 and receives sets of code optimisations such as 901, each with variables of interest and benefits, in a following step 1102, performed by a processor 1205 directed by a IBR software application 1233. A subsequent step 1103, performed by a processor 1205 directed by a IBR software application 1233, ranks the compulsory code optimisations high, as shown in the example segment 706. A following step 1104, performed by a processor 1205 directed by a IBR software application 1233, ranks mutually exclusive code optimisations low as depicted by the low rank metric subset 708. As depicted in the example 900, the mutual exclusiveness between code optimisations is determined by checking for common variables as well as negative interdependency between the techniques used (as depicted in FIG. 8).

A following step 1105, performed by a processor 1205 directed by a IBR software application 1233, ranks the code optimisations which have minimal benefits with common variables low as explained in example 900 of FIGS. 9A-9D. A subsequent step 1106, performed by a processor 1205 directed by a IBR software application 1233, determines the Coefficient of Variation (CV) of the remaining (i.e., unranked) metric subsets, such as 905 and 906. The initial ranking is performed in a step 1107, performed by a processor 1205 directed by a IBR software application 1233, between the metric subsets using the computed CV, and the lower the CV the higher the rank.

The process continues ranking the code optimisations which have the highest number of metrics having common variables in a step 1108, performed by a processor 1205 directed by a IBR software application 1233. If there are multiple options where common variables span across the same number of metrics, then the ranking is performed based on the computed CV. For example, if the common variables ‘a,b’ are in three code optimisations from three different metrics, such as memory consumption, bandrate and complexity, as well three other different metrics with a different combinations of variables, such as memory consumption, complexity and parallelisation, then the set which has the lowest CV across all the resultant metrics is chosen as the higher rank. For any other similar scenarios where it is not possible to make a decision based on either the benefit or the number of metrics containing common variables, the CV will be used for ranking.

Once there are no longer any overlap, as determined by a decision step 1109, performed by a processor 1205 directed by a IBR software application 1233, a following step 1110, performed by a processor 1205 directed by a IBR software application 1233, ranks the remaining code optimisations, after ranking the ones which have common variables, based on the CV by ranking each level at a time. The method 1100 terminates at a step 1111.

### EMBODIMENT 2

Another possible requirement for ranking can be to rank the code optimisations based on user preference of metrics. For example, the algorithm developer can say that the bandrate metric is the most important metric for embedded hardware friendliness, and hence code optimisations which have high advantages on bandrate should be ranked high.

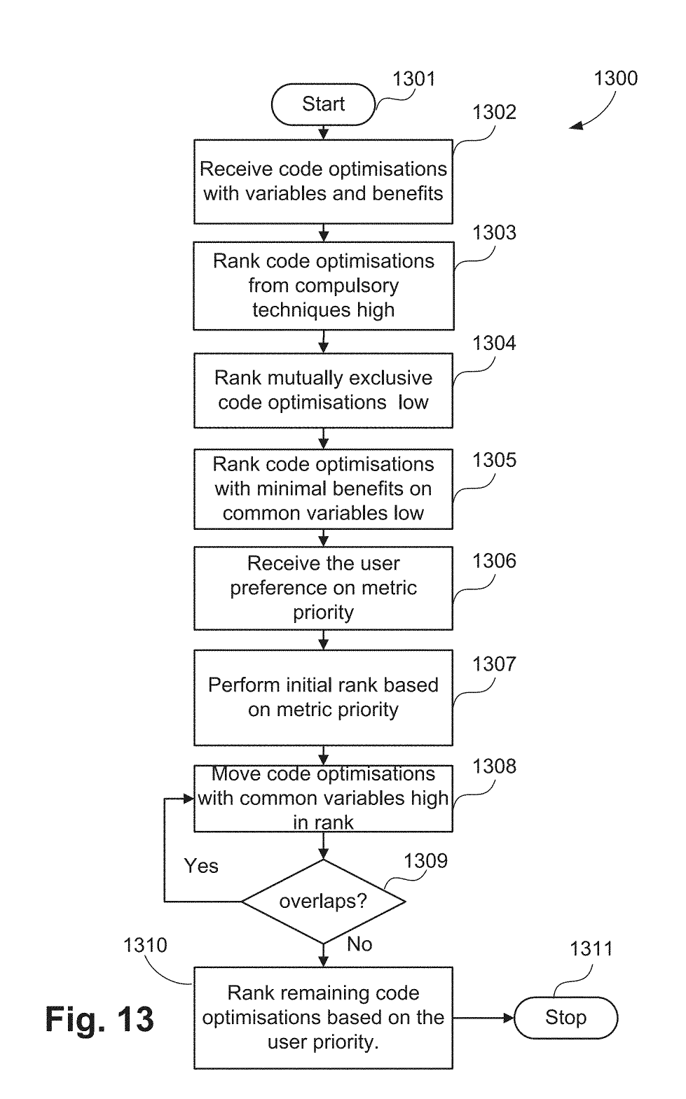

FIG. 13 depicts an alternative method 1300 for ranking, based on user priority on metrics. The method 1300 starts at a step 1301 and receives the sets of code optimisations such as 901 at a step 1302, performed by a processor 1205 directed by a IBR software application 1233, where the code optimisations contain the variables of interest and benefits for each code optimisation. A following step 1303, performed by a processor 1205 directed by a IBR software application 1233, ranks the code optimisations with compulsory techniques high in a similar manner to the step 1103 in the method 1100. A subsequent step 1304, performed by a processor 1205 directed by a IBR software application 1233, ranks mutually exclusive code optimisations low, in a manner similar to the step 1104 in the method 1100. A following step 1305, performed by a processor 1205 directed by a IBR software application 1233, ranks the code optimisations with minimal benefits on common variables low, in a similar manner to the step 1105 in the method 1100.

A subsequent step 1306, performed by a processor 1205 directed by a IBR software application 1233, receives the user priority in regard to metrics and a subsequent step 1307, performed by a processor 1205 directed by a IBR software application 1233, performs an initial ranking of the sets of code optimisations into respective metric subsets based on the user priority. A following step 1308, performed by a processor 1205 directed by a IBR software application 1233, ranks the code optimisations which are of higher priority based upon the user preference, and which have maximal common variables, into the high rank metric subset (eg 706 in FIG. 7). For example, if the user specifies the bandrate metric as being of higher priority than the memory consumption metric, and if there are two sets of code optimisations having common variables with the same number of metrics, the set which has bandrate will be assigned higher priority. A subsequent check step 1309, performed by a processor 1205 directed by a IBR software application 1233, keeps iterating the ranking step 1308 until there are no common variables remaining in the remaining code optimisations. A subsequent step 1310, performed by a processor 1205 directed by a IBR software application 1233, ranks the unranked code optimisations based on the user priority (e.g., rank bandrate code optimisations are ranked higher than all the remaining memory consumption based code optimisations if the bandrate metric is assigned higher priority than the memory consumption metric). The process then terminates at a step 1311.

Another alternative ranking method can be to evaluate a estimated performance cost of each code optimisation and follow either the method 1100 in FIG. 11, or the method 1300 in FIG. 13. The performance cost is defined as the effect in performance degradation or improvement of the algorithm software code when applying a specific code optimisation. For example when tiling a ‘for’ loop the performance of the ‘for’ loop can degrade from 1000 cycles to 1500 cycles, incurring a performance cost of 500 cycles. Such a performance cost can be used as a combination of either CV or user priority when ranking.

### EMBODIMENT 3

Another aspect of this IBR arrangement is the presentation and reporting of these ranked code optimisations in the Graphical User Interface (GUI) 107 in order to enable the algorithm developer to effectively and easily perform exploration of the algorithm software code. In order to do that different visual representations are proposed in order to report the behaviour of the algorithm software code for different metrics.

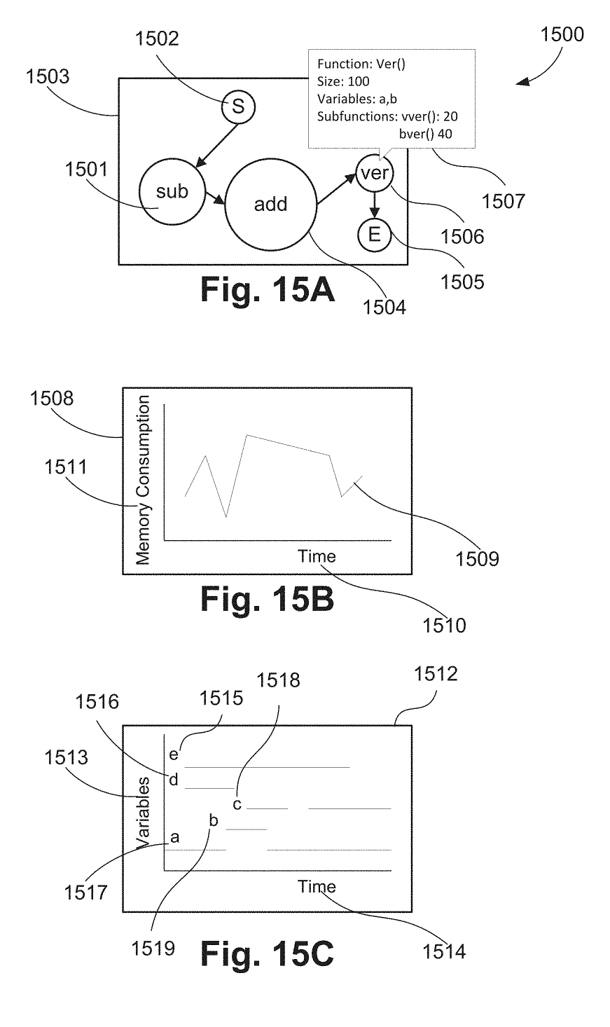

FIGS. 15A, 15B and 15C depict examples of preferred visualisation representations for the memory consumption metric.

FIG. 15A shows an example visual representation (referred to as a “functions dependency graph”) 1503, which highlights the functions in the algorithm software code as well as their connectivity. All the nodes are sized based on the estimated size of the function, which is computed by summing all the sizes of variables used inside each function. Reference numerals 1501, 1504 and 1506 depict functions ‘sub’, ‘add’ and ‘ver’ respectively which are used in the software algorithm code. Nodes S 1502 and E 1505 show entry and exit points of the graph respectively. A mouseover feature (this referring to the case when the user hovers the pointer associate with the pointing device 1203 over a feature displayed on the GUI 107 without “clicking” the control of the pointing device) is introduced to enable reporting a summary of each function as shown in 1507 when the pointing device is hovered over 1506. The information in 1507 includes the memory consumption of the function and the sub functions within the function. As indicated in 1507 the ‘ver’ function has a memory consumption of size 100 (this could be in any fundamental units, Bytes for example), including variables ‘a’ and ‘b’ with sub functions ‘vver’ and ‘bver’ consuming 20 and 40 sizes respectively.

FIG. 15B shows another visual representation 1508 (referred to as ‘memory footprint graph’) to report the dynamic memory consumption of the software algorithm code. An x-axis 1510 refers to time (this can be in seconds) and a y-axis 1511 refers to the memory consumption (this can be in Bytes). A line plot 1509 shows memory consumption of the software application code across the entire execution of the application.

FIG. 15C shows a different visual representation (referred to as ‘variables lifetime graph’), where an x-axis 1514 represents time (this can be in Seconds) and a y-axis 1513 represents the variables, such as ‘a’ 1517, ‘b’ 1519, ‘c’ 1518, ‘d’ 1516 and ‘e’ 1515. Horizontal bars in FIG. 15C shows the time during which each variable is live during the entire execution of the algorithm software code. For example, the variables ‘a’ 1517 and ‘b’ 1519 do not have an overlapping lifetime, as the bars are depicted as being interleaved. Similarly the variables ‘d’ 1516 and ‘c’ 1518 do not have an overlap in lifetime. The lifetime of a variable is defined as the situation in which variable is used in the code but not needed during the execution of the code. Such lifetime information is analysed to find the code optimisations for the reuse technique, using the post processing step in 405 in which the algorithm code is changed according to the data 413 collected in the IBR process.

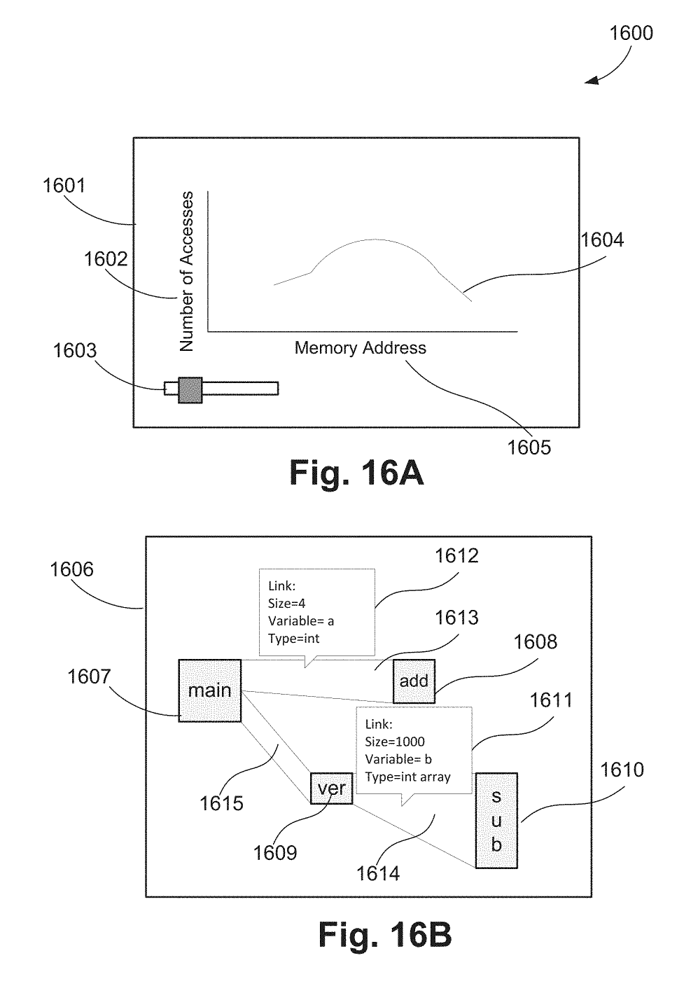

FIGS. 16A and 16B depict examples 1600 of visualisation representations for the bandrate metric (in FIG. 16A) and the complexity metric (in FIG. 16B).

An example 1601 in FIG. 16A shows a visual representation (referred to as ‘memory access trend’) depicting a number of memory accesses (along a y-axis 1602) for each memory address (along an x-axis 1605) in a ‘for’ loop of the algorithm software code. A sliding bar 1603 enables progressive visualisation of the behaviour across iterations of the ‘for’ loop. The algorithm developer is able to understand the memory access behaviour of the algorithm software code using this visual representation 1601.

The post processing step 405 is applied to this data to find code optimisations using techniques such as tiling, fusion and data merging.

An example 1606 in FIG. 16B depicts a visual representation (referred to as ‘transfer graph’) for the complexity metric, where function calls in the algorithm software code are analysed to find the communication pattern and sizes between function calls. Reference numerals 1607, 1608, 1609 and 1610 depict function calls ‘main’, ‘add’, ‘ver’ and ‘sub’ respectively. Reference numerals 1615, 1613 and 1614 depict data dependency links between the function calls. A mouseover effect is applied on links to identify the sizes of the link, the associated variables and the type, as shown at 1612 for the link between 1607 and 1608, and at 1611 for the link between 1609 and 1610. This visual representation allow the algorithm developer to find code optimisations related to reduction as pointed out in the example 800 in FIG. 8.

Returning to FIG. 4, once the code optimisations are found by post processing at the step 405 during the analysis step of 103, and after ranking in the step 109, the ranked code optimisations are then displayed on the GUI 107 based on the preference of the algorithm developer for exploration.

FIGS. 10A, 10B and 10C depict examples 1000 of preferred interactive visualisation representations for the algorithm developer which enable her to explore different code optimisations to evaluate the benefits and costs related to hardware friendliness.

FIG. 10A depicts an initial reporting of code optimisations when the algorithm developer requests the first 5 code optimisations, which span into two metrics namely a ‘functions dependency graph’ 1001 for the memory consumption metric, and a ‘memory access trend’ graph 1002 for the bandrate metric, in this example. Two code optimisations 1008 (based on the reduction technique with a benefit of 40 and a rank of 3 where ‘R’ refers to rank) and 1007 (based on the reuse technique with a benefit of 50 and rank of 1) are displayed for functions ‘sub’ 1009 and ‘add’ 1010 respectively in 1001. Note that a ‘ver’ function 1011 does not have code optimisations within the first 5 ranks requested.

Similarly three code optimisations 1016 (based on the tiling technique with a benefit of 20 and a rank of 2), 1015 (based on the merging technique with a benefit of 100 and rank of 4) and 1014 (based on fusion technique with a benefit of 50 and a rank of 5) are displayed in 1002.

FIG. 10B articulates an example scenario where the algorithm developer performs a mouse over for a code optimisation 1021. The displayed code optimisations 1021, 1020 in a frame 1003, and displayed code optimisations 1022, 1023 and 1024 in a frame 1004, are highlighted differently for code optimisations which are compliant, and uncompliant, with the code optimisation 1021. The term “compliant” in the context of code optimisations refers to code optimisations which can be used together (ie which are usable together), complimentary code optimisations being an example of such compliant code optimisations. The term “uncompliant” in the context of code optimisations refers to code optimisations which cannot be used together (ie which are not usable together), mutually exclusive code optimisations being an example of such uncompliant code optimisations. In this example, the uncompliant code optimisations are shown in striped format (such as 1022 and 1024), while compliant code optimisations, such as 1021 and 1020 are shown in highlighted format. This differentiated format display shows that when the code optimisation 1021 is chosen, the code optimisations 1022 and 1024 cannot be applied.

Finally when the algorithm developer clicks one or many compliant code optimisations for exploration, the displays are updated for the chosen code optimisations, highlighting the benefits and performance gain or costs related to the selected code optimisation or code optimisations.

FIG. 10C depicts a scenario in which the algorithm developer selects code optimisation (at 1025), which then updates the graph to show the estimated benefits. An ‘add’ function 1026 is reduced in size (i.e., depicting improved memory consumption using the reuse technique) due to the selection code optimisation 1025. Even though the code optimisation 1025 is generally aimed at the memory consumption metric in 1005, the applied code optimisation can also affect all the other metrics, such as bandrate in this example, and hence that effect is also reported at 1027.

In order to simplify comparisons, the IBR arrangement overlays original visuals such as 1028 over 1027 (the overlay in the frame 1005 is not shown). The overall improvement to the algorithm is estimated and reported for benefits and performance cost or gain (not shown).

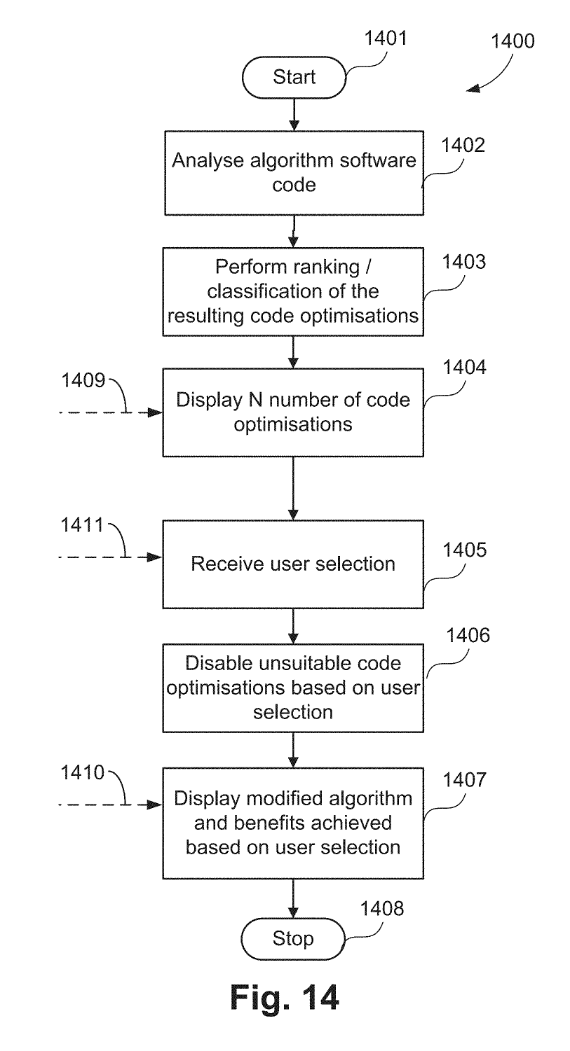

FIG. 14 depicts a preferred method 1400 for performing interactive exploration using the GUI 107 as described in relation to the example 1000 in FIGS. 10A-10C. The method commences with a step 1401, after which a step 1402, performed by a processor 1205 directed by a IBR software application 1233, analyses the algorithm software code in order to find optimisations, as depicted at the step 103 in FIG. 1. A following step 1403, performed by a processor 1205 directed by a IBR software application 1233, performs ranking of the identified code optimisations (also see the step 109). This has the effect of classifying complementary code optimisations as belonging to a higher rank metric subset, mutually exclusive code optimisations as belonging to a lower rank metric subset, and remaining code optimisations as belonging to an intermediate rank metric subset.

A subsequent step 1404, performed by a processor 1205 directed by a IBR software application 1233, displays the top N number of code optimisations in the GUI 107 based on a preference 1409 from the algorithm developer, similar to the example depicted in FIG. 10A. A user selection 1411 by the algorithm developer is received in a following step 1405, performed by a processor 1205 directed by a IBR software application 1233, which then displays, in a following step 1406, performed by a processor 1205 directed by a IBR software application 1233, compliant (suitable) and uncompliant (unsuitable) code optimisations within the N number of code optimisations using distinguishing display formats such as shown in the examples 1023, and 1022, 1024 in FIG. 10B. The visualisations are updated according to the user selection, in a manner similar to the example depicted in FIG. 10C, and a sample snippet of the modified algorithm is reported (not shown) in a subsequent step 1407, performed by a processor 1205 directed by a IBR software application 1233.

The user selection 1411 at the step 1405 may be a mouseover (this being referred to as a “designation” rather than a “selection”) in which the user hovers the pointer of the pointing device 1203 over the code optimisation of interest (thereby designating but not selecting the noted code optimisation), in which case the steps 1406 and 1407 display the changes that would occur if the user were actually to select the code optimisation in question. The process may then loop back to the user preference 1409 and the step 1404 to enable the user to specify different preferences. The user selection 1411 at the step 1405 may alternately be an actual selection of the code optimisation of interest (this being referred to as a selection rather than a designation) in which case the steps 1406 and 1407 display the changes that now will occur as the user has actually selected the code optimisation in question.

Furthermore, following the display in the step 1406 of the compliant (suitable) and uncompliant (unsuitable) code optimisations within the N number of code optimisations selected on the basis of the user preference 1409, the user can actually select, as depicted by a dashed arrow 1410, the code optimisation or optimisations of interest (this selection step is not shown), after which the step 1407 forms combinations of code optimisations based on the selection 1410 of the user, modifies the algorithm software code, and displays the modified algorithm and benefits actually achieved based on the user selection.

The method 1400 may then loop back to the user preference 1409 and step 1404 to enable the user to specify different preferences, or may terminate in a step 1408.

### INDUSTRIAL APPLICABILITY

The arrangements described are applicable to the computer and data processing industries and particularly for the system on a chip embedded software fabrication and design industry.

The foregoing describes only some embodiments of the present invention, and modifications and/or changes can be made thereto without departing from the scope and spirit of the invention, the embodiments being illustrative and not restrictive.

1. A method of selecting a software code optimisation for a section of algorithm software code in order to modify resource usage of hardware that executes the section of algorithm software code, the method comprising the steps of:
classifying each of a plurality of software code optimisations, each of the software code optimisations characterising modifications to the section of software code that modify the hardware resource usage;
forming combinations of the software code optimisations, each of the combinations containing at least two of the software code optimisations and being formed according to an interdependency of the optimisation techniques of the software code optimisations in the combination, wherein the software code optimisations of each combination are useable together; and
modifying the section of software code with at least two of the software code optimisations belonging to a selected combination of the set of combinations in order to modify the resource usage of the hardware executing the section of software code.

2. The method according to claim 1 wherein the classifying step comprises determining a rank for each of the plurality of software code optimisations based on benefits of the software code optimisations.

3. The method according to claim 2, wherein the determination of the rank is dependent upon the mean and the standard deviation of the benefits of the software code optimisations.

4. The method according to claim 2, wherein the determination of the rank is dependent upon a user preference.

5. The method according to claim 2, wherein the determination of the rank further depends upon presence of common variables in the software code optimisations.

6. The method according to claim 1, wherein:
the classifying step comprises classifying the software code optimisations into one of a high rank metric subset, a low rank metric subset, and an intermediate rank metric subset; and
the forming step forms combinations from software code optimisations in the intermediate rank metric subset.

7. The method according to claim 1 further comprising:
determine a rank for each of the software code optimisations based on a benefit of the optimisation, the benefit being based on the determined interdependency; and
modifying the section of software code with the at least two of the software code optimisations further selected according to the determined rank.

8. The method according to claim 7 wherein the rank is also determined based on the classification of the optimisations, and usage of variables in the software code optimisation.

9. The method according to claim 7 wherein the rank is also determined based on a predetermined weighting based on the classification of the optimisation.

10. The method according to claim 1 wherein the plurality of software code optimisations modify different resource types, the resource types being selected from the set of band-rate, memory consumption, complexity, parallelisation and power.

11. The method according to claim 10 wherein the selected combination contains software code optimisations that modify at least two different resource types.

12. The method according to claim 1 wherein the resource usage of the software code optimisations is determined according to at least one hardware architecture.

13. The method according to claim 7 wherein the modifying the section of software code further comprises balancing the modification of the resource usage of the section of software code with a performance loss caused by the software code optimisations that modify the selection of software code.

14. A method of selecting software code optimisations for a section of algorithm software code to modify resource usage of hardware that executes the section of algorithm software code, the method comprising the steps of:
displaying a plurality of software code optimisations for the section of software code, each of the software code optimisations characterising modifications to the section of software code that modifies resource usage;
determining that one of the plurality of software code optimisations for the section of software code has been designated; and
displaying at least one additional software code optimisation from the plurality of software code optimisations, the additional software code optimisation being displayed in a format dependent upon whether additional software code optimisation can be used together with the software code optimisation that has been designated.

15. The method according to claim 14, comprising the further steps of:
selecting the designated software code optimisation and at least one displayed additional software code optimisations displayed in a format indicating that the additional software code optimisation can be used together with the selected software code optimisation; and
modifying the section of software code with the selected software code optimisation and the at least one additional software code optimisation to modify the resource usage of the hardware executing the section of software code.

16. The method according to claim 14, wherein the displaying step displays one or more of:
a functions dependency graph, which highlights functions in the algorithm software code as well as their connectivity;
a memory footprint graph, to report the dynamic memory consumption of the software algorithm code;
a variables lifetime graph which shows the time when each variable is live during the entire execution of the algorithm software code;
a memory access trend to realise the number of memory accesses for each memory address; and
a transfer graph which shows data dependency links between the function calls.

17. An apparatus for selecting a software code optimisation for a section of algorithm software code in order to modify resource usage of hardware that executes the section of algorithm software code, the apparatus comprising:
a memory storing a computer executable software program; and
a processor for executing the software program to perform a method comprising the steps of:
classifying each of a plurality of software code optimisations, each of the software code optimisations characterising modifications to the section of software code that modify the hardware resource usage;
forming combinations of the software code optimisations, each of the combinations containing at least two of the software code optimisations and being formed according to an interdependency of the optimisation techniques of the software code optimisations in the combination, wherein the software code optimisations of each combination are useable together; and
modifying the section of software code with at least two of the software code optimisations belonging to a selected combination of the set of combinations in order to modify the resource usage of the hardware executing the section of software code.

18. An apparatus for selecting software code optimisations for a section of algorithm software code to modify resource usage of hardware that executes the section of algorithm software code, the apparatus comprising:
a memory storing a computer executable software program; and
a processor for executing the software program to perform a method comprising the steps of:
displaying a plurality of software code optimisations for the section of software code, each of the software code optimisations characterising modifications to the section of software code that modifies resource usage;
determining that one of the plurality of software code optimisations for the section of software code has been designated; and
displaying at least one additional software code optimisation from the plurality of software code optimisations, the additional software code optimisation being displayed in a format dependent upon whether additional software code optimisation can be used together with the software code optimisation that has been designated.

19. A non-transitory computer readable memory storage medium storing a computer executable software program for selecting a software code optimisation for a section of algorithm software code in order to modify resource usage of hardware that executes the section of algorithm software code, the program comprising:
software executable code for classifying each of a plurality of software code optimisations, each of the software code optimisations characterising modifications to the section of software code that modify the hardware resource usage;
software executable code for forming combinations of the software code optimisations, each of the combinations containing at least two of the software code optimisations and being formed according to an interdependency of the optimisation techniques of the software code optimisations in the combination, wherein the software code optimisations of each combination are useable together; and
software executable code for modifying the section of software code with at least two of the software code optimisations belonging to a selected combination of the set of combinations in order to modify the resource usage of the hardware executing the section of software code.

20. A non-transitory computer readable memory storage medium storing a computer executable software program for selecting software code optimisations for a section of algorithm software code to modify resource usage of hardware that executes the section of algorithm software code, the program comprising:
software executable code for displaying a plurality of software code optimisations for the section of software code, each of the software code optimisations characterising modifications to the section of software code that modifies resource usage;
software executable code for determining that one of the plurality of software code optimisations for the section of software code has been designated; and
software executable code for displaying at least one additional software code optimisation from the plurality of software code optimisations, the additional software code optimisation being displayed in a format dependent upon whether additional software code optimisation can be used together with the software code optimisation that has been designated.
